(19) United States
(12) Patent Application Publication
(10) Pub. No.: US 2021/0372106 A1
(43) Pub. Date: Dec. 2, 2021

(54) Food waste disposer and integrated sink and integrated cabinet

(71) Applicant: Gong Zhu, Xiamen (CN)

(72) Inventor: Gong Zhu, Xiamen (CN)

(21) Appl. No.: 17/211,847

(22) Filed: Mar. 25, 2021

(30) Foreign Application Priority Data
Jun. 1, 2020 (CN) 2020104862737

(51) Int. Cl. E03C 1/266; B02C 18/16; B02C 18/00; F16L 17/02

(52) U.S. Cl. CPC E03C 1/2665; B02C 18/16; B02C 2201/063; F16L 17/02; B02C 18/0092

(57) ABSTRACT

The invention relates to the field of kitchen appliances and discloses a food waste disposer, the food waste disposer has a switching component arranged to a discharge outlet of the food waste disposer, the switching component has a first pipe; a second pipe; a first baffle that flips in an anti-gravity direction along a discharge direction to connect or isolate a discharge outlet and a sewer pipe; a first sealing ring; and a limit block to prevent the first baffle from flipping. The invention also discloses an integrated sink and integrated cabinet both have the food waste disposer with a switching component arranged to a discharge outlet of the food waste disposer.

### CROSS-REFERENCE TO RELATED APPLICATIONS

This application claims priority to Chinese Patent Application No. 202010486273.7, filed on 1 Jun. 2020, the disclosure of which is hereby incorporated herein by reference in its entirety.

### BACKGROUND OF THE INVENTION

The invention relates to the field of kitchen appliances, especially to a food waste disposer.

In the field of small kitchen appliances, a food waste disposer is usually installed under a sink in a kitchen. Food waste is put into a feed inlet of the food waste disposer through the sink. Food waste is crushed in a cavity of the food waste disposer while being brought into a feed inlet through water flow and then discharged into a sewer pipe. After long-term use, a large number of residue particles often remain in the cavity of the food waste disposer. These residues accumulate in every corner of the cavity over time. Since existing food waste disposers do not yet have a function of cleaning inside of the cavity. Therefore residues remaining in the cavity produce peculiar smell after fermentation, and also cause a reduction of crushing efficiency of the food waste disposer. Especially when the food waste disposer is not used for a period of time due to a business trip, when the food waste disposer is used again, peculiar smell emitted from the cavity is more obvious. Usually a maintenance master disassembles the entire food waste disposer and then cleans the inside of its cavity. At this time, peculiar smell is often emitted from the cavity of the disposer. The reason is that a long-term use of the food waste disposer causes crushed food residue particles to adhere to the inside of the cavity, and emits peculiar smell after long-term accumulation and fermentation. Even if the food waste disposer is cleaned in a long-term flow mode after each use, there will still be a peculiar smell coming out of the feed inlet of the disposer. This peculiar smell is not all from the sewer pipe. Since the discharge outlet of the food waste disposer and the sewer pipe are separated by a U-shaped structure, peculiar smell in the sewer pipe is isolated. A long-term accumulation of food residue particles in a pipe part between the U-shaped structure and the discharge outlet of the food waste disposer emits the peculiar smell after fermentation, such peculiar smell directly enters the cavity of the food waste disposer through the discharge outlet of the food waste disposer, then it is emitted through the feed inlet of the food waste disposer. Since existing food waste disposers adopt a constant flow mode to pulverize food waste, some waste is not pulverized into fine particles before being carried by the water flow into the discharge outlet and then discharged into the sewer pipe. After an accumulation of these particles over time, it is inevitable that the sewer pipe will be blocked. In order to make the crushed particles smaller and finer to avoid clogging the sewer pipe after discharge, some manufacturers increase a crushing effect by increasing the number of crushing blades. However, such design solution increases a volume of the food waste disposer, or reduces a space for accommodating materials in the cavity while keeping the volume unchanged, and at the same time increases the number of corners in the cavity where material particles can be attached.

### BRIEF SUMMARY OF THE INVENTION

The present invention aims to provide a food waste disposer, which can facilitate cleaning of a cavity of the food waste disposer without disassembling the cavity, thereby preventing waste particles from remaining in the cavity for a long time and causing peculiar smell to be emitted.

Such object is achieved by providing a food waste disposer as defined in claim 1, further advantageous according to the invention will be apparent from the dependent claims.

The present invention provides a food waste disposer, the food waste disposer comprises a feed inlet; a discharge outlet; a cavity arranged between the feed inlet and the discharge outlet; a pulverizing component arranged in the cavity for pulverizing materials; a driving component arranged outside the cavity for driving the pulverizing component; and a power input terminal for driving the driving component to work. The discharge outlet is provided with a switching component in a detachable manner, the switching component comprises a first pipe arranged along a discharge direction of the discharge outlet; a first baffle that is arranged at an end of the first pipe away from the discharge outlet and used to prevent discharge and can be turned against gravity direction; a first sealing ring arranged between the first pipe and the first baffle; and a retractable limit block controlled by a control component to prevent the first baffle from turning over through a connecting component. The first pipe comprises a channel arranged therein; and the channel connects the discharge outlet with a sewer pipe.

The present invention further aims to provide an integrated sink containing the above-mentioned food waste disposer, which can easily clean a cavity of the food waste disposer without disassembling the food waste disposer installed below the sink, thereby avoiding long-term residue of waste particles in the cavity and cause peculiar smell to be emitted.

Such object is achieved by providing an integrated sink, the integrated sink comprises a sink; a faucet installed above the sink; and a food waste disposer connected below the sink. The food waste disposer comprises a feed inlet; a discharge outlet; a cavity arranged between the feed inlet and the discharge outlet; a pulverizing component arranged in the cavity for pulverizing materials; a driving component arranged outside the cavity for driving the pulverizing component; and a power input terminal for driving the driving component to work. The discharge outlet is provided with a switching component in a detachable manner, the switching component comprises a first pipe arranged along a discharge direction of the discharge outlet; a first baffle that is arranged at an end of the first pipe away from the discharge outlet and used to prevent discharge and can be turned against gravity direction; a first sealing ring arranged between the first pipe and the first baffle; and a retractable limit block controlled by a control component to prevent the first baffle from turning over through a connecting component. The first pipe comprises a channel arranged therein; and the channel connects the discharge outlet with a sewer pipe. The feed inlet of the food waste disposer is connected with a drain outlet of the sink, the control component is arranged on a countertop of the sink.

The present invention further aims to provide an integrated cabinet containing the above-mentioned food waste disposer, which can easily clean a cavity of the food waste disposer without disassembling the food waste disposer installed in the cabinet, thereby avoiding long-term residue of waste particles in the cavity and cause peculiar smell to be emitted.

Such object is achieved by providing an integrated cabinet, the integrated cabinet comprises a cabinet; a sink embedded in a countertop of the cabinet; a faucet installed above the sink; and a food waste disposer connected below the sink. The food waste disposer comprises a feed inlet, a discharge outlet, a cavity arranged between the feed inlet and the discharge outlet, a pulverizing component arranged in the cavity for pulverizing materials, a driving component arranged outside the cavity for driving the pulverizing component, and a power input terminal for driving the driving component to work. The discharge outlet is provided with a switching component in a detachable manner, the switching component comprises a first pipe arranged along a discharge direction of the discharge outlet, a first baffle that is arranged at an end of the first pipe away from the discharge outlet and used to prevent discharge and can be turned against a direction of gravity, a first sealing ring arranged between the first pipe and the first baffle, and a retractable limit block controlled by a control component to prevent the first baffle from turning over through a connecting component. The first pipe comprises a channel arranged therein, and the channel connects the discharge outlet with a sewer pipe. The feed inlet of the food waste disposer is connected with the drain outlet of the sink, the control component is arranged on a countertop of the sink.

### Advantageous Effects

1. A cavity of the food waste can be filled with water when a switching component is in a closed state. A pulverizing component drives water flow in the cavity to flush the cavity, components in the cavity, and all corners of the cavity to achieve clean cleaning of the cavity and avoid peculiar smell generation.

2. After the cavity is flushed, operate a movable end of a control component to release a restriction effect of a limit block on a first baffle. At a moment when the limit block is released, with the help of pressure of water in the cavity, water instantly rushes through the first baffle and enters a sewer pipe. Such pressurized water flow can flush the sewer pipe clean and avoid the sewer pipe blockage.

3. Since the first baffle is arranged at a distance from a discharge outlet, that is, a length of a first pipe, the first baffle is opened when the cavity is filled with water, and water in the first pipe is discharged first. After water in the cavity enters the first pipe, a vortex can be generated under a drainage of the first pipe. The vortex allows water in the cavity to flow without being driven by the pulverizing component, and then food particles washed down from all corners of the cavity are taken out of the cavity and discharged into the sewer pipe. At the same time, the vortex also accelerates water in the cavity to drain into the sewer pipe.

4. When the switching component is in a closed state, food waste is continuously pulverized into particles in the cavity, the continuous pulverization makes the particles finer and smaller. The food waste can be pulverized into slurry, and it is not easy to block the sewer pipe after discharge.

5. When the switching component is in a closed state, water is retained in the cavity, and food waste is crushed, which improves water utilization rate and avoids waste of water resources in a working model of smashing food waste and draining water under a constant flow state.

6. An opening direction of the first baffle of the switching component is flipped along an anti-gravity direction of discharging direction. Such opening direction has no block or hindrance to the discharging, such arrangement solves a problem of unreliable closing of the first baffle caused by some high-fiber residues hanging on the first baffle.

7. Since the limit block and the first baffle are in intermittent contact and are not continuously connected as a whole, the first baffle automatically clings to an inclined surface under gravity after the limit block is away from the first baffle. The automatic closing of the discharge outlet can be realized without manually pressing the control component, under action of a first sealing ring, the discharge outlet is kept in a closed state, which avoids a backflow of peculiar smell in the sewer pipe, or a backflow of sewage, or an intrusion of insects.

8. Since an end of the first pipe far away from the discharge outlet is designed with an inclined surface, the first baffle can be close to the first sealing ring on the inclined surface under gravity action so that the discharge outlet is kept in a closed state, which avoids a backflow of peculiar smell in sewer pipe, or a backflow of sewage, or an intrusion of insects.

9. A second pipe is provided with a third through hole and a fourth through hole, which can dredge sewage that penetrates into an end cover due to a reduced tightness of a third sealing ring, thereby preventing the sewage in the end cover from entering the cabinet.

10. A double-L-shaped rotating holding structure of the control component enables the first baffle of the switching component to be always kept in a tightly closed position, thereby the discharge outlet is always kept in a tightly closed state.

11. As the second baffle is provided, other equipments connected with a third pipe is automatically isolated from the sewer pipe so as to avoid a backflow of peculiar smell in the sewer pipe, or a backflow of sewage, or an intrusion of insects.

12. Due to arrangements of the first baffle, the second baffle, and the end cover, hidden dangers of peculiar smells in the sewer pipe, sewage reflux, and insects intruding into kitchen are completely eliminated.

13. Closing function of the discharge outlet makes the cavity easy to clean, an opening direction of the discharge outlet makes it difficult for materials to hang on a baffle when the food waste disposer is discharging. In order to avoid a problem of unreliable closing of the discharge outlet and to maintain a normal use of closing function of the discharge outlet, arrangement of the inclined surface makes the baffle of the food waste disposer automatically close to isolate the sewer pipe when it is not discharging.

### BRIEF DESCRIPTION OF THE SEVERAL VIEWS OF THE DRAWINGS

Further characteristics and advantages of the invention will emerge from the description of preferred, non-limiting examples of which are provided in the attached drawings, in which:

FIG. 1 is a perspective view of a food waste disposer in accordance with an embodiment of the present invention;

FIG. 2 is a cross-sectional view of a food waste disposer in FIG. 1 along a plane where an axis of a cavity and an axis of a discharge outlet are located, wherein a limit block is far away from a first baffle;

FIG. 3 is a cross-sectional view of a food waste disposer in FIG. 1 along a plane where an axis of a cavity and an axis of a discharge outlet are located, wherein a limit block abuts a first baffle;

FIG. 4 is a cross-sectional view of a food waste disposer in FIG. 1 along a plane where an axis of a cavity and an axis of a discharge outlet are located, wherein a first baffle is partially opened;

FIG. 5 is a cross-sectional view of a food waste disposer in FIG. 1 along a plane where an axis of a cavity and an axis of a discharge outlet are located, wherein a first baffle is opened;

FIG. 6 is a 3d-drawing of a switching component;

FIG. 7 is a cross-sectional view of a control component along a central plane parallel to a first slideway;

FIG. 8 is a partially cut-away perspective view of a control component in accordance with an embodiment of the present invention;

FIG. 9 is a partially cut-away perspective view of a control component in accordance with an embodiment of the present invention;

FIG. 10 is an exploded perspective view of FIG. 6;

FIG. 11 is an exploded perspective view of a connecting component and a control component;

FIG. 12 is an exploded perspective view of a movable end in accordance with an embodiment of the present invention;

FIG. 13 is a partial perspective view of a control component in accordance with an embodiment of the present invention;

FIG. 14 is a partial perspective view of a control component in accordance with an embodiment of the present invention, wherein a fifth lug is in a first slideway;

FIG. 15 is a partial perspective view of a control component in accordance with an embodiment of the present invention, wherein a fifth lug is located at a junction between a first slideway and a second slideway;

FIG. 16 is a partial perspective view of a control component in accordance with an embodiment of the present invention, wherein a fifth lug is in a second slideway;

FIG. 17 is a perspective view of a first fixing base in accordance with an embodiment of the present invention;

FIG. 18 is a partial enlarged view of part A in FIG. 4;

FIG. 19 is a perspective view of a limit block in accordance with an embodiment of the present invention;

FIG. 20 is a flowchart of a method for processing food waste in accordance with an embodiment of the present invention;

FIG. 21 is a flowchart of a method for cleaning a food waste disposer in accordance with an embodiment of the present invention;

FIG. 22 is a perspective view of a food waste disposer in accordance with another embodiment of the present invention;

FIG. 23 is a cross-sectional view of a food waste disposer in FIG. 22 along a plane where an axis of a cavity and an axis of a discharge outlet are located, wherein a limit block abuts a first baffle and a second baffle;

FIG. 24 is a cross-sectional view of a food waste disposer in FIG. 22 along a plane where an axis of a cavity and an axis of a discharge outlet are located, wherein a first baffle is opened and a second baffle is closed;

FIG. 25 is a cross-sectional view of a food waste disposer in FIG. 22 along a plane where an axis of a cavity and an axis of a discharge outlet are located, wherein a first baffle is closed and a second baffle is opened;

FIG. 26 is a perspective cross-sectional view of a third pipe;

FIG. 27 is a perspective view of a third pipe;

FIG. 28 is a perspective view of a first pipe;

FIG. 29 is an exploded perspective view of a connecting component in FIG. 22;

FIG. 30 is a perspective view of a control component in accordance with another embodiment of the present invention, wherein a movable end is at a first position;

FIG. 31 is a perspective view of a control component in FIG. 30, wherein a movable end is at a second position;

FIG. 32 is a cross-sectional view of a control component in FIG. 30,

FIG. 33 is a perspective view of a baffle;

FIG. 34 is a perspective view of a second fixing base;

FIG. 35 is a partial enlarged view of part B in FIG. 32;

FIG. 36 is an exploded perspective view of a control component in FIG. 32;

FIG. 37 is a perspective view of an integrated sink in accordance with an embodiment of the present invention;

FIG. 38 is a perspective view of an integrated cabinet in accordance with an embodiment of the present invention.

List of Reference Characters

| | | |
|---|---|---|
| 1. feed inlet; | 2. discharge outlet; | 3. switching component; |
| 4. connecting component; | 5. control component; | 6. cavity; |
| 7. third pipe; | 31. first pipe; | 32. second pipe; |
| 33. first sealing ring; | 34. first baffle; | 35. first pin; |
| 36. limit block; | 37. fourth sealing ring; | 38. first tube nut; |
| 39. third sealing ring; | 30. sixth sealing ring; | 310. second tube nut; |
| 311. first lug; | 312. first groove; | 313. first blind hole; |
| 314. first through hole; | 315. first rib; | 321. first nozzle; |
| 322. second nozzle; | 323. third nozzle; | 324. fourth nozzle; |
| 325. fifth nozzle; | 326. sixth nozzle; | 327. third through hole; |
| 328. fourth through hole; | 329. fourth groove; | 331. pillar; |
| 341. second lug; | 342. sixth groove; | 343. third blind hole; |
| 361. board; | 362. lug boss; | 41. core part; |
| 42. retainer sleeve; | 43. end cover; | 44. first adapter sleeve; |
| 45. second adapter sleeve; | 46. grommet; | 47. fifth sealing ring; |
| 51. first fixing base; | 52. movable end; | 53. pull rod; |
| 54. second fixing base; | 55. clamp nut; | 56. third adapter sleeve; |
| 57. washer; | 58. response unit; | 59. nine sealing ring; |
| 512. third magnet; | 513. first slideway; | 514. second slideway; |
| 515. seventh lug; | 521. second magnet; | 522. fourth magnet; |
| 523. fifth lug; | 524. first slot; | 525. second slot; |
| 526. third slot; | 527. handle end; | 528. shaft portion; |
| 571. fourth lug; | 581. elastic component; | 582. push rod; |
| 583. third fixing base; | 584. wall; | 585. fifth through hole; |
| 586. sixth lug; | 587. fourth blind hole; | 588. sixth through hole; |
| 511. first magnet; | 71. third tube nut; | 72. seventh sealing ring; |
| 73. eithth sealing ring; | 74. second rib; | 75. second baffle; |
| 76. second sealing ring; | 77. second groove; | 78. second blind hole; |
| 79. third lug; | 710. second through hole; | 711. rim. |

### DETAILED DESCRIPTION OF THE INVENTION

### Embodiment One

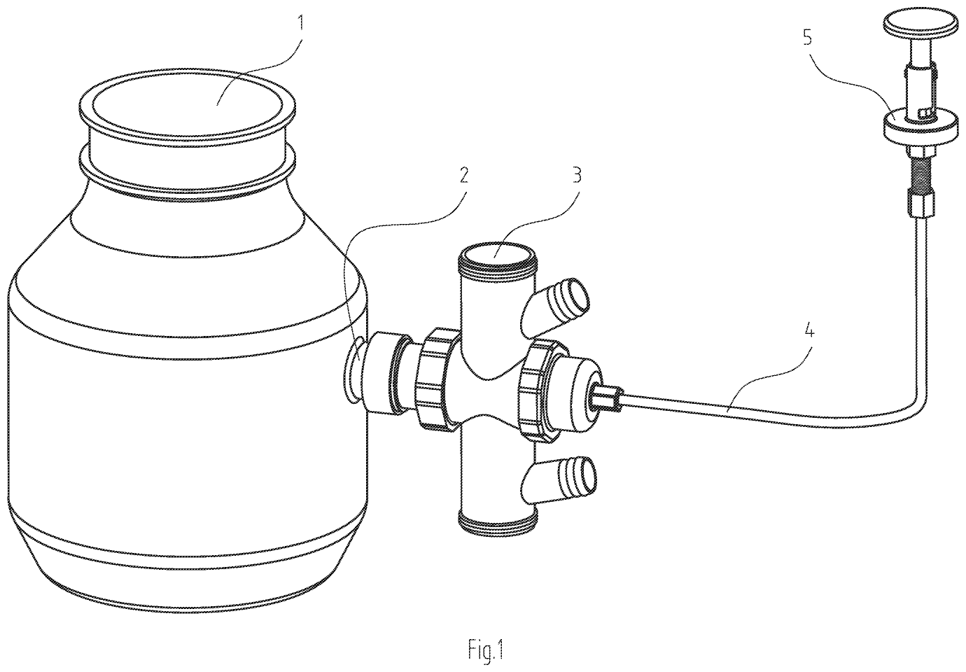

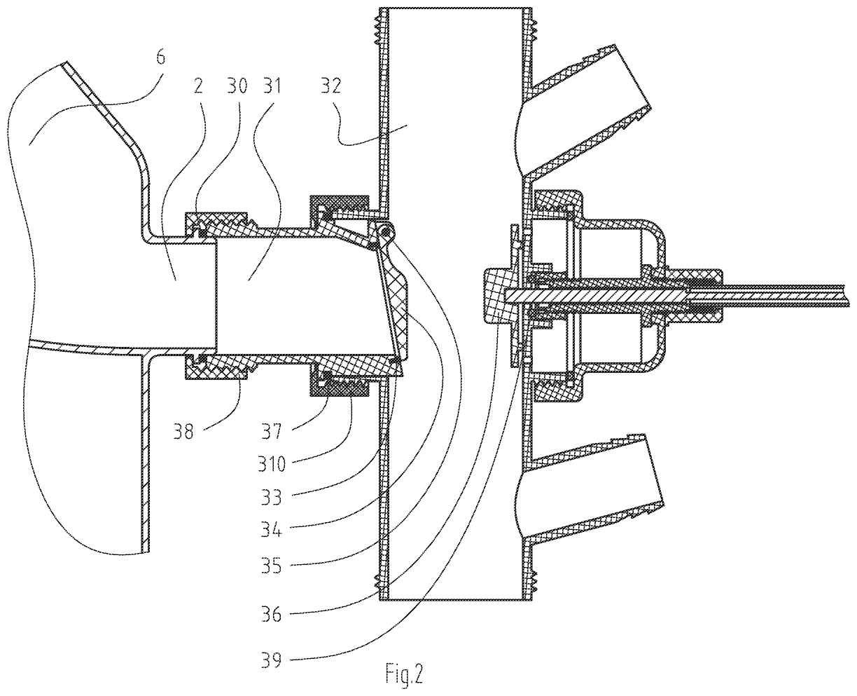

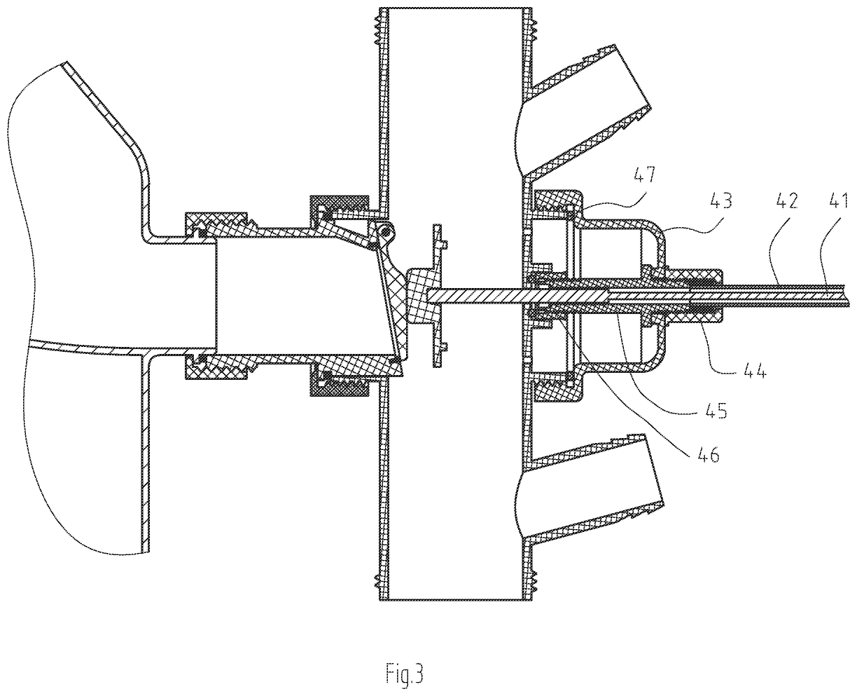

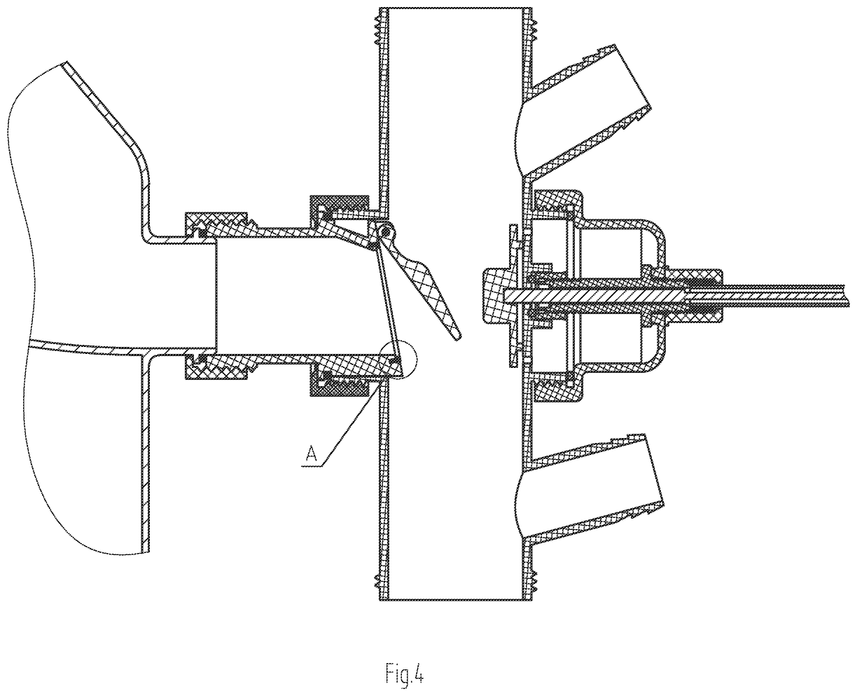

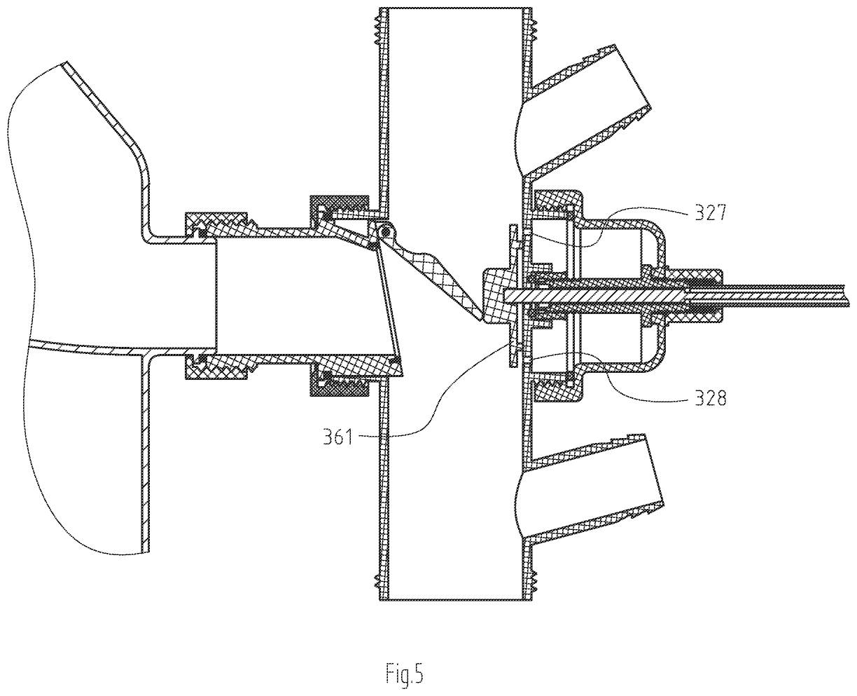

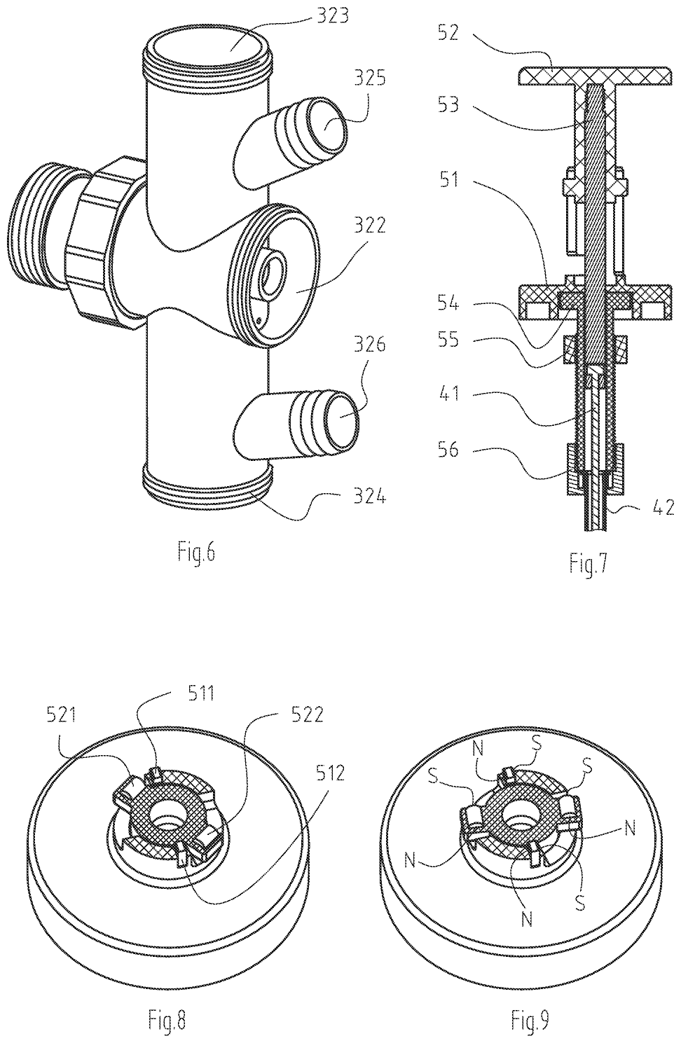

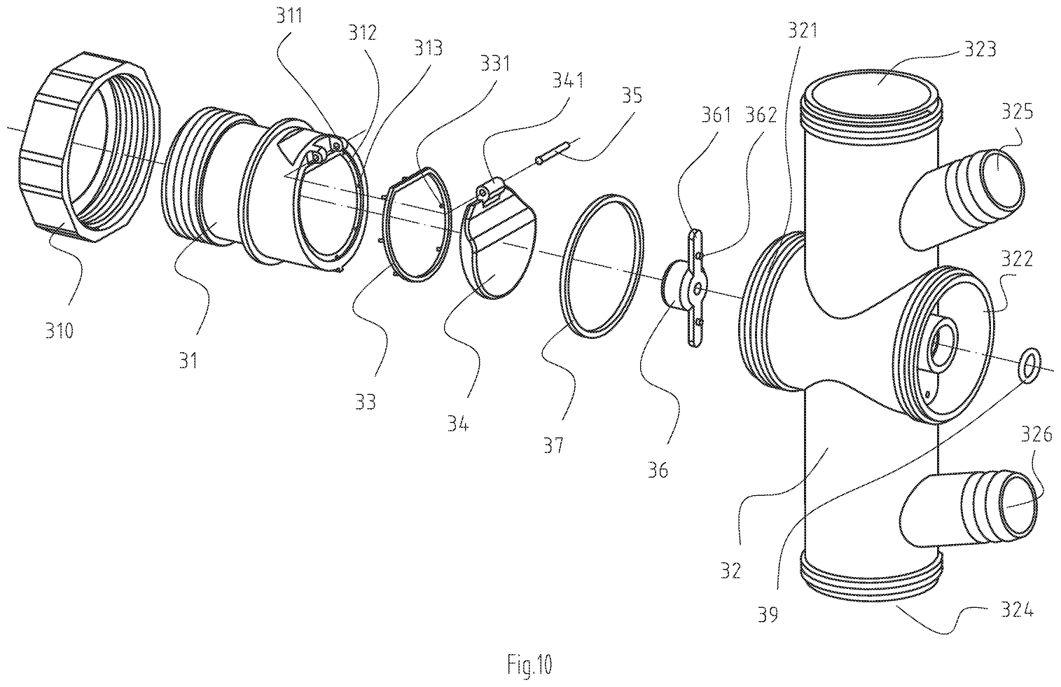

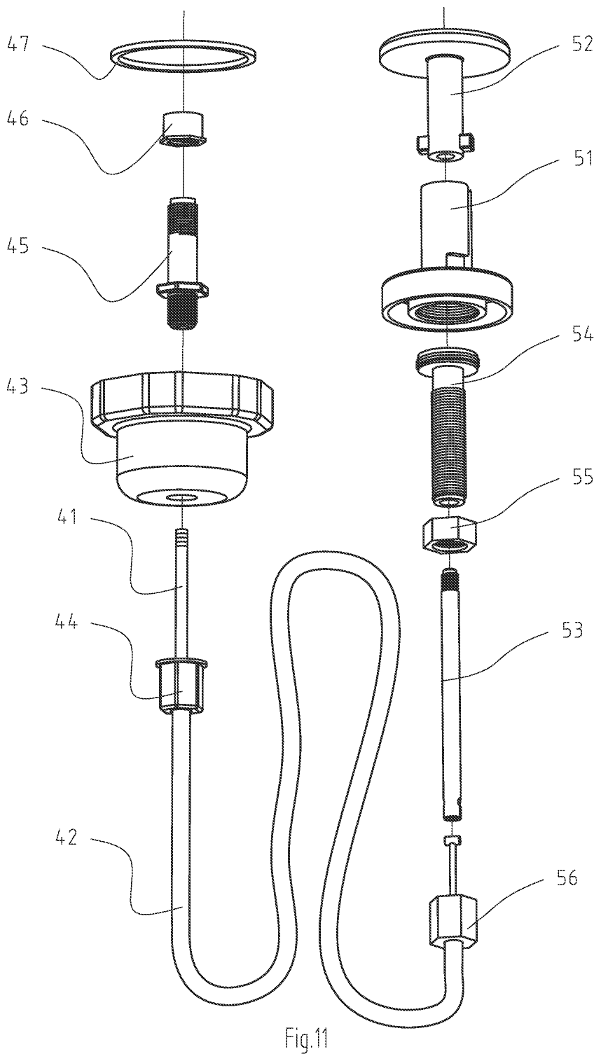

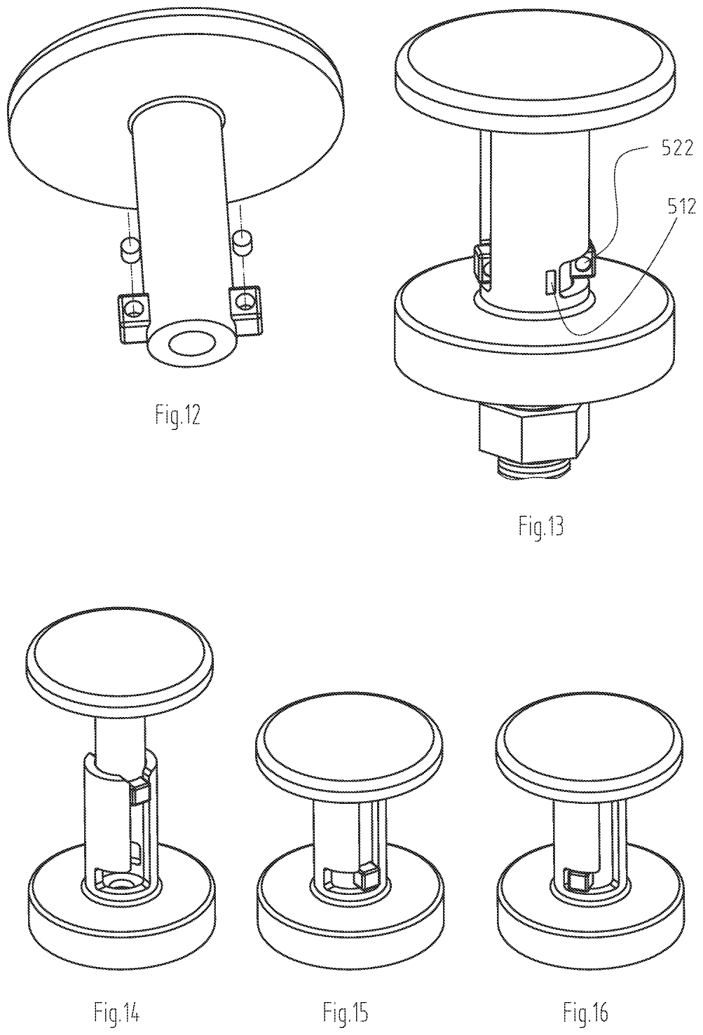

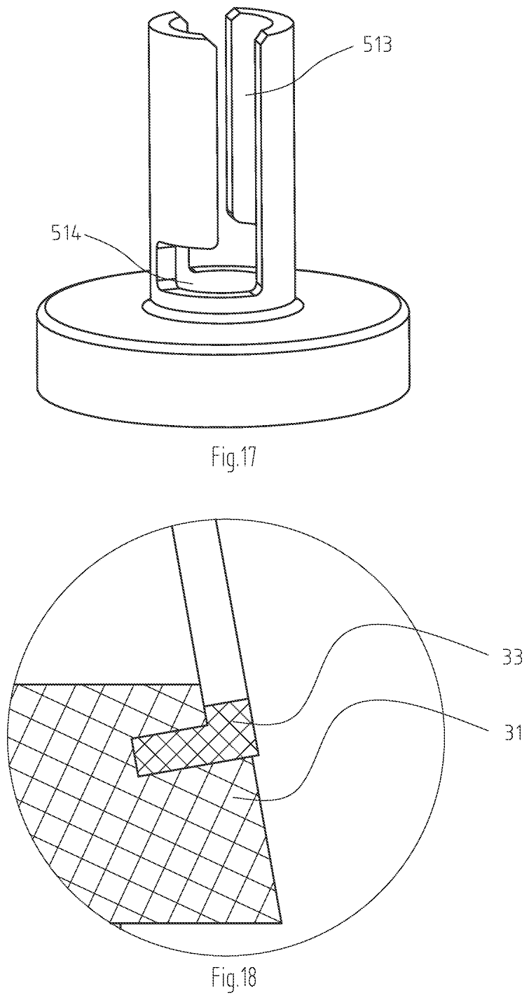

An example of a food waste disposer having discharge outlet 2 with closing function is shown in FIG. 1, the food waste disposer comprises a feed inlet 1; a discharge outlet 2; a cavity 6 arranged between a feed inlet 1 and a discharge outlet 2; a pulverizing component arranged in the cavity 6 for pulverizing materials; a driving component arranged outside the cavity 6 for driving the pulverizing component; and a power input terminal for driving the driving component to work. The food waste disposer further comprises a switching component 3 that is detachably coupled to the discharge outlet 2 in a threaded connection manner; a control component 5 that prompts the switching component 3 to close; and a connecting component 4 that connects the switching component 3 and the control component 5. The connecting component 4 is a flexible element to allow the control component 5 to be flexibly installed on a countertop of a sink so as to facilitate a user operation. The switching component 3 is also provided with multiple nozzles to allow pipe connections of other equipments in a kitchen and connection with a sewer pipe.

Arrange the switching component 3 to the discharge outlet 2 and make the switching component 3 close the discharge outlet 2 through the control component 5, feed a water into the feed inlet 1 of the food waste disposer so that water fills the cavity 6 of the food waste disposer. When the switching component 3 is closed, water in the cavity 6 is driven by the pulverizing component to flush the cavity 6, components in the cavity 6, and all corners of the cavity 6 so as to realize a clean cleaning of the cavity 6 and avoid a generation of peculiar smell. Therefore the food waste disposer disclosed in this embodiment can clean the cavity 6 without disassembling the cavity 6.

In addition, arrange the switching component 3 to the discharge outlet 2 and make the switching component 3 close the discharge outlet 2 through the control component 5 so that food waste and water are sent into the cavity 6 through the feed inlet 1 of the food waste disposer and then stay in the cavity 6 to be crushed, continuous crushing can obtain smaller and finer material particles; therefore, the food waste can be crushed into slurry under a mixing of water, and it is not easy to block a sewer pipe after being discharged. Therefore the food waste disposer disclosed in this embodiment can pulverize the food waste into slurry without increasing the number of pulverizing blades.

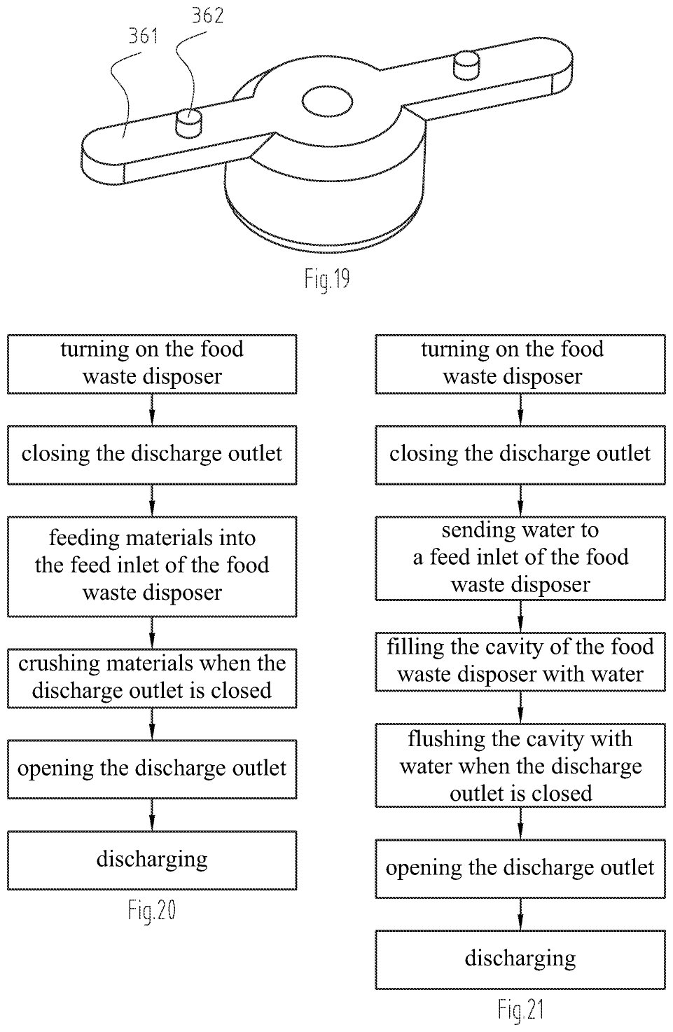

Referring to FIG. 2, the switching component 3 comprises a first pipe 31 arranged along a discharge direction of the discharge outlet 2; a first baffle 34 that is arranged at an end of the first pipe 31 away from the discharge outlet 2 and used to prevent discharge and can be turned against gravity direction; a first sealing ring 33 arranged between the first pipe 31 and the first baffle 34, and a retractable limit block 36 controlled by the control component 5 to prevent the first baffle 34 from turning over through the connecting component 4. The first pipe 31 comprises a channel arranged therein, the channel connects the discharge outlet 2 with the sewer pipe. The first pipe 31 and the discharge outlet 2 of the food waste disposer are sealed by a sixth sealing ring 30, and the first pipe 31 is tightly connected with the discharge outlet 2 through a first tube nut 38.

Referring to FIG. 10, an end of the first pipe 31 of the switching component 3 away from the discharge outlet 2 is provided with an inclined surface inclined to the discharge outlet 2, a first groove 312 for partially receiving the first sealing ring 33 is arranged perpendicular to the inclined surface, a first blind hole 313 that is in interference fit with the first sealing ring 33 is arranged perpendicular to the first groove 312, a pair of first lugs 311 are arranged perpendicular to the inclined surface along a direction away from the discharge outlet 2, the first lug 311 is provided with a first through hole 314 for clearance matching with a first pin 35 to allow the first pin 35 to rotate relative to the first through hole 314. Since an end of the first pipe 31 away from the discharge outlet 2 is designed with an inclined surface, the first baffle 34 can automatically close to the first sealing ring 33 on the inclined surface under gravity action so that the discharge outlet 2 is automatically kept in a closed state to prevent a peculiar smell in the sewer pipe from flowing back into the food waste disposer, or to prevent a peculiar smell emitted from fermented food residue particles after being accumulated for a long time in a pipe part between a U-shaped structure of the sewer pipe and the discharge outlet 2 from fleeing into the food waste disposer, or to prevent a sewage in the sewer pipe from flowing back into the food waste disposer, or to prevent insects in the sewer pipe from crawling into the food waste disposer. Since the first baffle 34 is arranged at a distance from the discharge outlet 2, that is, a length of the first pipe 31, the first baffle 34 is opened when the cavity 6 is filled with water, and water in the first pipe 31 is discharged first. After water in the cavity 6 enters the first pipe 31, a vortex can be generated under a drainage of the first pipe 31. The vortex allows water in the cavity 6 to flow without being driven by the pulverizing component, and then food particles washed down from all corners of the cavity 6 are taken out of the cavity 6 and discharged into the sewer pipe. At the same time, the vortex also accelerates water in the cavity 6 to drain into the sewer pipe.

Referring to FIG. 10, the first sealing ring 33 comprises an outer shape corresponding to the first groove 312 provided on the inclined surface of the first pipe 31; and a pillar 331 that is interference fit with the first blind hole 313. The first sealing ring 33 is arranged between the inclined surface of the first pipe 31 and the first baffle 34, the first sealing ring 33 partially protrudes from the inclined surface, as shown in FIG. 18. Arrangement of protruding from the inclined surface of the first sealing ring 33 can increase a service life of the switching component 3, a protruding part of the first sealing ring 33 can be used to offset a wear caused by frequent opening and closing of the first baffle 34. The first baffle 34 has an outer shape corresponding to the inclined surface of the first pipe 31 and a second lug 341 that is rotatably coupled with the first lug 311 provided on the inclined surface through the first pin 35, the first lug 311 and the second lug 341 are connected by a rotation connection of the first pin 35 to realize the first baffle 34 to turn around the first pin 35; therefore, the first baffle 34 automatically clings to the first sealing ring 33 under gravity action. When discharging, due to an impulse of materials, the first baffle 34 turns around the first pin 35 in an opposite direction of gravity. Such opening direction does not block or hinder the discharge, and solves a problem of unreliable closing of the first baffle 34 due to part of high-fiber residues hung on the first baffle 34. The limit block 36 can slide along an axial direction of the first pipe 31 under control of the control component 5 after the limit block 36 is connected to the connecting component 4, an end of the limit block 36 close to the discharge outlet 2 is used to limit the turning of the first baffle 34 so as to make the first baffle 34 close to the first sealing ring 33 so that materials are closed inside the cavity 6 of the food waste disposer.

Referring to FIG. 3 and FIG. 11, the connecting component 4 comprises a retainer sleeve 42; a core part 41 accommodated in the retainer sleeve 42 and sliding relative to the retainer sleeve 42; an end cover 43 threadedly coupled with the second pipe 32; a first adapter sleeve 44 and a second adapter sleeve 45 coaxially penetrating through the end cover 43 to fasten the retainer sleeve 42; and a grommet 46 screwed to the second adapter sleeve 45 close to the discharge outlet 2 for sealing. The end cover 43 is fastened to the second pipe 32 by a threaded connection manner, the end cover 43 and the second pipe 32 are sealed by a fifth sealing ring 47. An end of the core part 41 of the connecting component 4 close to the discharge outlet 2 penetrates the second pipe 32 and is tightly coupled with the limit block 36 of the switching component 3 through a threaded connection manner. The core part 41 is slidable relative to the second pipe 32, the grommet 46 is hermetically connected with the second pipe 32 of the switching component 3 through a third sealing ring 39.

In order to enable an end of the core part 41 close to the discharge outlet 2 to slide relative to the second pipe 32, the second pipe 32 is provided with a central hole coaxially along the end of the core part 41, a rim 711 is extended outwards coaxially with the central hole to form a recess for receiving the grommet 46, a third groove for partially receiving the third sealing ring 39 is provided in the recess coaxially with the central hole. The second adapter sleeve 45 is fastened to the end cover 43 through a threaded connection of the first adapter sleeve 44 and the second adapter sleeve 45, a position of the grommet 46 on the second adapter sleeve 45 is adjusted by the threaded connection to realize that the grommet 46 squeezes the third sealing ring 39, in this way, an inside of the second pipe 32 is sealed and isolated from an inside of the end cover 43, furthermore, a sewage in the second pipe 32 is prevented from entering an inner part of the end cover 43 through a gap between the central hole and the core part 41.

Referring to FIG. 5, in order to avoid a problem that sewage in the second pipe 32 penetrates into the end cover 43 due to a reduced tightness of the third sealing ring 39, the second pipe 32 fitting is provided with a third through hole 327 and a fourth through hole 328. The third through hole 327 and the fourth through hole 328 are symmetrically arranged on an upper side and a lower side of the central hole (when the food waste disposer is upright). The third through hole 327 is located at the upper side of the center hole, the fourth through hole 328 is located at the lower side of the center hole. The fourth through hole 328 is used to dredge the sewage that penetrates into an inner part of the end cover 43 due to reduced tightness of the third sealing ring 39 so as to prevent the sewage in the end cover 43 from entering a cabinet. The third through hole 327 is used to keep an air pressure in the end cover 43 consistent with another air pressure in the second pipe 32 so that the sewage that has penetrated into the end cover 43 can be smoothly left out of the end cover 43 under gravity action.

Referring to FIG. 5, in order to prevent materials from entering the end cover 43 through the third through hole 327 or the fourth through hole 328 during discharging, an end of the limit block 36 away from the discharge outlet 2 is symmetrically arranged with a board 361 along a radial direction outwards, the second pipe 32 is provided with the third through hole 327 and the fourth through hole 328 close to the board 361, a radial dimension of the board 361 is greater than a distance between the third through hole 327 and the fourth through hole 328.

In order to maintain a certain distance between the third through hole 327 or the fourth through hole 328 and the board 361 to keep an air pressure in the end cover 43 consistent with the another air pressure in the second pipe 32, two lug boss 362es protruding vertically from the board 361 are symmetrically arranged on the board 361 of the limit block 36, as shown in FIG. 19, the two lug boss 362es and the third through hole 327 or the fourth through hole 328 are arranged in a staggered position, the lug boss 362 abuts an inner wall 584 of the second pipe 32 to limit a length of a movable end 52 of the control component 5 protruding from a first fixing base 51.

Referring to FIG. 10, the second pipe 32 is provided with multiple nozzles to allow pipe connections of other equipments in kitchen and connection with a sewer pipe. The second pipe 32 is provided with a first nozzle 321 for socketing an inclined end of the first pipe 31, an outer peripheral surface of the first nozzle 321 is provided with a thread and is detachably connected to the first pipe 31 through a second tube nut 310, as shown in FIG. 6. An airtight connection of the first nozzle 321 between the first pipe 31 and the second pipe 32 is realized by a fourth sealing ring 37. The second pipe 32 is provided with a second nozzle 322 coaxially along a direction of the discharge outlet 2 and is connected with the connecting component 4 in a threaded connection manner. The second pipe 32 has a third nozzle 323 perpendicular to a direction of the discharge outlet 2 and is connected to a drainage outlet of other equipment by a threaded connection manner. The second pipe 32 is provided with a fourth nozzle 324 coaxial with the third nozzle 323 and along gravity direction, the third nozzle 323 is connected with the sewer pipe in a threaded connection manner. The second pipe 32 is provided with a fifth nozzle 325 obliquely upward on a side of the second nozzle 322 (when the food waste disposer is upright). The fifth nozzle 325 is located between the second nozzle 322 and the third nozzle 323. The second pipe 32 is provided with a sixth nozzle 326 obliquely upward on a side of the second nozzle 322 (when the food waste disposer is upright). The sixth nozzle 326 is located between the second nozzle 322 and the fourth nozzle 324, the fifth nozzle 325 or the sixth nozzle 326 can be used for but not limited to connecting an overflow pipe of the sink.

Referring to FIG. 7 and FIG. 11, the control component 5 comprises the first fixing base 51; the movable end 52 coaxially inserted into the first fixing base 51; a connecting rod that is coaxially fastened and connected to the movable end 52 and extends in a direction away from the movable end 52; a second fixing base 54 that is coaxially and detachably fastened to the first fixing base 51 away from the movable end 52 by a threaded connection manner; a clamp nut 55 coaxially arranged on the second fixing base 54 in a threaded connection manner for installing the control component 5 at a proper position; and a third adapter sleeve 56 that is coaxially arranged on the second fixing base 54 away from the movable end 52 in a threaded connection manner for fastening the retainer sleeve 42 of the connecting component 4 to the control component 5. The connecting rod has a concave part engaged with an end hook part of the core part 41 to realize a position control of the movable end 52 of the first baffle 34.

Referring to FIG. 17, a cylindrical surface of the first fixing base 51 is axially provided with a first slideway 513, an end of the first slideway 513 away from the movable end 52 extends along the cylindrical surface to form a second slideway 514, the second slideway 514 is perpendicular to the first slideway 513, the first slideway 513 is connected to the second slideway 514.

Referring to FIG. 14 and FIG. 15, the movable end 52 has a shaft portion 528 slidingly fitted with the first fixing base 51, the shaft portion 528 extends radially outward to form a fifth lug 523, the fifth lug 523 slides in the first slideway 513 or the second slideway 514, the movable end 52 is slidably connected to the first slideway 513 through the fifth lug 523 to move the movable end 52 along an axial direction of the first fixing base 51.

Referring to FIG. 16, the movable end 52 rotates around an axis of the first fixing base 51 through a sliding connection between the fifth lug 523 and the second slideway 514 when the fifth lug 523 slides into the second slideway 514, the second slideway 514 restricts an axial movement of the movable end 52.

Referring to FIG. 8 and FIG. 13, a cylindrical surface of the first fixing base 51 is inlaid with a first magnet 511 close to the second slideway 514, the fifth lug 523 of the movable end 52 is inlaid with a second magnet 521, poles of the first magnet 511 and the second magnet 521 are opposite to each other, as shown in FIG. 9, so that the fifth lug 523 enters the second slideway 514 due to an action of magnetic force to drive the movable end 52 rotate when the fifth lug 523 is located at a junction between the first slideway 513 and the second slideway 514.

Referring to FIG. 17, the first slideway 513 and the second slideway 514 constitutes an L-shaped slideway, the first fixing base 51 is provided with two L-shaped slideways that are distributed on a cylindrical surface of the first fixing base 51 in a circular array with an axis of the first fixing base 51 as a central axis and spaced by 180 degrees. A double-L-shaped rotating holding structure of the first fixing base 51 enables the first baffle 34 of the switching component 3 to be always kept in a tightly closed position, thereby the discharge outlet 2 is always kept in a tightly closed state.

Referring to FIG. 8, the first fixing base 51 is provided with a third magnet 512, the first magnet 511 and the third magnet 512 is embedded in the first fixing base 51 in a circular array with an axis of the first fixing base 51 as a central axis and spaced by 180 degrees. The movable end 52 is providing with two fifth lugs 523 that are distributed in a circular array with an axis of the movable end 52 as a central axis and spaced by 180 degrees, as shown in FIG. 12. The fifth lug 523 is providing a fourth lug 571, the second magnet 521 and the fourth magnet 522 are embedded in the fifth lug 523 in a circular array with an axis of the movable end 52 as a central axis and spaced by 180 degrees; poles of the third magnet 512 and the fourth magnet 522 are opposite to each other, as shown in FIG. 9. Since magnetic poles are oppositely arranged, the movable end 52 can be automatically rotated under an action of magnetic force after being pressed down to a certain depth so that the movable end 52 can be kept in a depressed state by itself, thereby eliminating a need for artificially rotating the movable end 52.

When it is necessary to release a restriction effect of the limit block 36 on the first baffle 34, rotate the movable end 52 so that the fifth lug 523 of the movable end 52 enters the first slideway 513 from the second slideway 514, the movable end 52 is slid away from the second slideway 514 through an elastic force of a spring (not shown), then the connecting rod is driven to move so that an end of the core part 41 of the connecting component 4 drives the limit block 36 far away from the first baffle 34 of the switching component 3. Thereby, the restriction effect of the limit block 36 on the first baffle 34 turning is released. Therefore the limit block 36 and the first baffle 34 adopt intermittent contact, rather than a continuous connection. The first baffle 34 automatically clings to the inclined surface under gravity action after the limit block 36 is far away from the first baffle 34, the discharge outlet 2 can be automatically closed without manually pressing the control component 5. The discharge outlet 2 is maintained under an action of the first sealing ring 33 so as to avoid a backflow of peculiar smell in sewer pipe, or a backflow of sewage, or an intrusion of insects.

An example of food waste treatment method that crushes the food waste into slurry and discharges it into the sewer pipe is shown in FIG. 20, the treatment method comprises turning on the food waste disposer to make the crushing component run; closing the discharge outlet 2 of the food waste disposer; and feeding materials into the feed inlet 1 of the food waste disposer, the materials contain water. The materials are crushed when the switching component 3 is closed, the materials in the cavity 6 of the food waste disposer are continuously crushed by the crushing component, continuous crushing can obtain finer and smaller material particles. Therefore the materials can be crushed into slurry with mixing of water. After the materials are crushed into slurry, a restriction effect of the limit block 36 on the first baffle 34 of the switching component 3 is released. The first baffle 34 of the switching component 3 is flipped along an anti-gravity direction of a discharging direction under an impact of the materials to discharge the slurry materials into the sewer pipe. The food waste treatment method makes water be retained in the cavity 6, and then the materials are crushed, which improves a utilization rate of water. It avoids waste of water resources by a working method of smashing the materials and draining water under a constant flow state.

A closing function of the switching component 3 is realized by the control component 5, and a method is as follows: pressing the movable end 52 of the control component 5 to make the limit block 36 abut the first baffle 34 through the connecting component 4; and turning the movable end 52 of the control component 5 to limit the movable end 52 to a current position. The limit block 36 is maintained at a current state of abutting the first baffle 34 so that the discharge outlet 2 is at a closed and locked state.

An opening function of the switching component 3 is automatically realized after the limit block 36 is removed, and a method is as follows: rotating the movable end 52 of the control component 5 to release an axial restriction of the movable end 52; and lifting the movable end 52 of the control component 5 to make the limit block 36 away from the first baffle 34 through the connecting component 4, thereby releasing a restriction effect of the limit block 36 on the first baffle 34. The first baffle 34 maintains a closed state of the discharge outlet 2 under gravity action. An impulse of the materials makes the first baffle 34 flip in an anti-gravity direction of discharge direction, as shown in FIG. 4 and FIG. 5, the materials are then discharged into the sewer pipe.

An example of cleaning method of the food waste disposer that avoids the material particles remaining in the cavity 6 is shown in FIG. 21, the cleaning method comprises turning on the food waste disposer to make the crushing component run; closing the discharge outlet 2 of the food waste disposer; sending water to the feed inlet 1 of the food waste disposer; and filling the cavity 6 of the food waste disposer with water. Water in the cavity 6 is driven by the pulverizing component to flush the cavity 6 and components in the cavity 6 and all corners of the cavity 6 when the switching component 3 is closed, a clean cleaning of the cavity 6 is realized to avoid a generation of peculiar smell. In order to improve cleaning efficiency, a cleaning agent can be added to water. After the cavity 6 has been flushed, operate the movable end 52 of the control component 5 to release a restriction effect of the limit block 36 on the first baffle 34. At a moment when the limit block 36 is lifted, water uses a pressure of water in the cavity 6 to instantly open the first baffle 34 and enter the sewer pipe. This pressurized water flow can flush the sewer pipe clean, avoiding the sewer pipe blockage, and a clean inner wall 584 of the pipeline is not easy to produce peculiar smell. Since the first baffle 34 has a certain distance from the discharge outlet 2, that is, a length of the first pipe 31. Therefore open the first baffle 34 when water fills the cavity 6, a part of water in the first pipe 31 is discharged first, and another water in the cavity 6 enters the first pipe 31 to produce a vortex under a drainage of the first pipe 31. The vortex makes water in the cavity 6 flow without being driven by the pulverizing component, furthermore, food particles that have been washed down from all corners of the cavity 6 are taken out of the cavity 6 and discharged into the sewer pipe. At the same time, the vortex also accelerates water in the cavity 6 to drain into the sewer pipe.

### Embodiment Two

Embodiment two is optimized and improved on the basis of a technical solution disclosed in Embodiment one. One baffle is added to isolate a sewer pipe on the basis of Embodiment one so as to completely prevent peculiar smell in the sewer pipe from entering a kitchen through other interfaces.

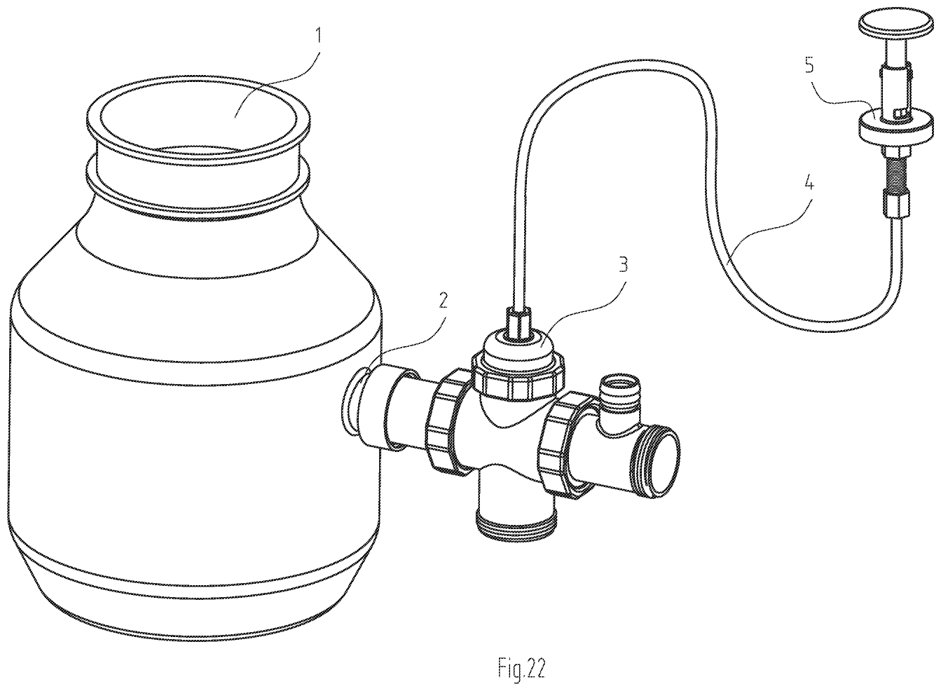

An example of a food waste disposer having discharge outlet 2 with closing function is shown in FIG. 22. The food waste disposer comprises a feed inlet 1; a discharge outlet 2; a cavity 6 arranged between a feed inlet 1 and a discharge outlet 2; a pulverizing component arranged in the cavity 6 for pulverizing materials; a driving component arranged outside the cavity 6 for driving the pulverizing component; and a power input terminal for driving the driving component to work. The food waste disposer further comprises a switching component 3 that is detachably coupled to the discharge outlet 2 in a threaded connection manner; a control component 5 that prompts the switching component 3 to close; and a connecting component 4 that connects the switching component 3 and the control component 5. The connecting component 4 is a flexible element to allow the control component 5 to be flexibly installed on a countertop of a sink so as to facilitate a user operation. The switching component 3 is also provided with multiple nozzles to allow pipe connection of other equipments in a kitchen and connection with a sewer pipe.

Arrange the switching component 3 to the discharge outlet 2 and make the switching component 3 close the discharge outlet 2 through the control component 5, feed water into the feed inlet 1 of the food waste disposer so that water fills the cavity 6 of the food waste disposer. When the switching component 3 is closed, water in the cavity 6 is driven by the pulverizing component to flush the cavity 6, components in the cavity 6, and all corners of the cavity 6 so as to realize a clean cleaning of the cavity 6 and avoid a generation of peculiar smell. Therefore the food waste disposer disclosed in this embodiment can clean the cavity 6 without disassembling the cavity 6.

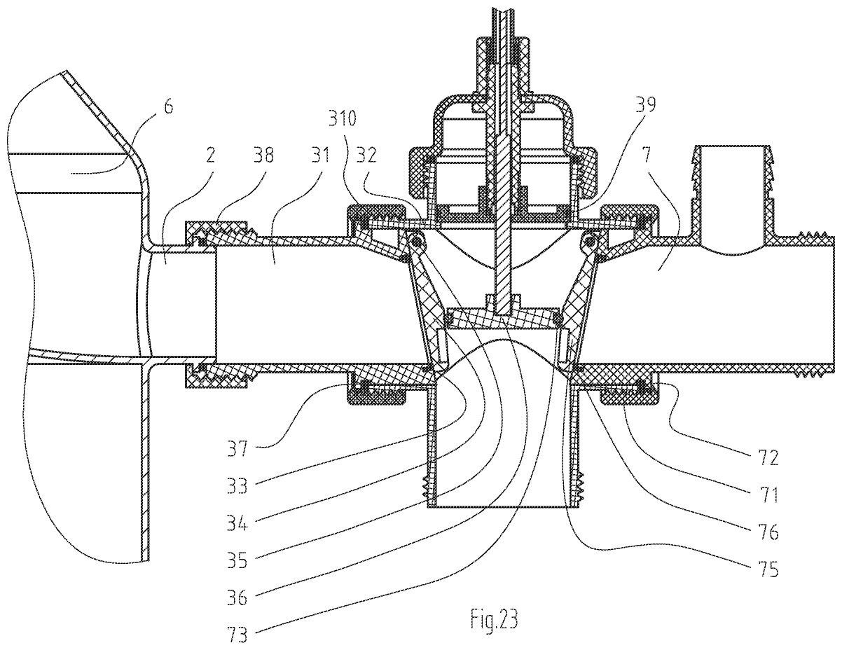

Referring to FIG. 23, the switching component 3 comprises a first pipe 31; a first baffle 34; a first sealing ring 33; a second pipe 32; a third pipe 7; a second baffle 75; a second sealing ring 76; and a retractable limit block 36 for preventing the first baffle 34 or the second baffle 75 turning over under control of the control component 5. The first pipe 31 is arranged along a discharge direction of the discharge outlet 2, the first baffle 34 is arranged at an end of the first pipe 31 away from the discharge outlet 2 for preventing discharge and the first baffle 34 flips in an anti-gravity direction. The first sealing ring 33 is arranged between the first pipe 31 and the first baffle 34, the second pipe 32 is partially sleeved with an end of the first pipe 31 away from the discharge outlet 2, the third pipe 7 is arranged coaxially with the first pipe 31. The second baffle 75 is arranged at an end of the third pipe 7 close to the discharge outlet 2 to prevent the discharge and the second baffle 75 flips in an anti-gravity direction. The second sealing ring 76 is arranged between the third pipe 7 and the second baffle 75, the third pipe 7 and the first pipe 31 are arranged symmetrically with respect to a central plane of the second pipe 32 perpendicular to the discharge direction, the second pipe 32 is partially sleeved with the third pipe 7 close to an end of the discharge outlet 2. An end of the limit block 36 close to the discharge outlet 2 is used to limit a turning of the first baffle 34 so that the first baffle 34 is close to the first sealing ring 33 to prevent materials from being discharged. An end of the limit block 36 away from the discharge outlet 2 is used to limit a turning of the second baffle 75 so that the second baffle 75 is close to the second sealing ring 76 to prevent materials from being discharged. The first pipe 31, the second pipe 32, and the third pipe 7 each has a channel arranged therein, and the channel connects the discharge outlet 2 of the food waste disposer with the sewer pipe.

An end of the first pipe 31 of the switching component 3 away from the discharge outlet 2 is provided with an inclined surface inclined to the discharge outlet 2, a first groove 312 for partially receiving the first sealing ring 33 is arranged perpendicular to the inclined surface, a first blind hole 313 that is in interference fit with the first sealing ring 33 is arranged perpendicular to the first groove 312, a pair of first lugs 311 are arranged perpendicular to the inclined surface along a direction away from the discharge outlet 2, the first lug 311 is provided with a first through hole 314 for clearance matching with a first pin 35 to allow the first pin 35 to rotate relative to the first through hole 314.

Referring to FIG. 27, An end of the third pipe 7 of the switching component 3 close to the discharge outlet 2 is provided with another inclined surface inclined in a direction away from the discharge outlet 2, a second groove 77 for partially receiving the second sealing ring 76 is arranged perpendicular to the another inclined surface, a second blind hole 78 that is in interference fit with the second sealing ring 76 is arranged perpendicular to the second groove 77, a pair of the third lugs 79 are arranged perpendicular to the another inclined surface along a direction close to the discharge outlet 2, the third lug 79 is provided with a second through hole 710 for clearance matching with a second pin to allow the second pin to rotate relative to the second through hole 710.

Since the first pipe 31 and the second pipe 32 are designed with inclined surfaces, the first baffle 34 and the second baffle 75 can automatically close to the first sealing ring 33 and the second sealing ring 76 on the inclined surfaces under gravity action so that the discharge outlet 2 is automatically kept in a closed state to prevent a peculiar smell in the sewer pipe from flowing back into the food waste disposer, or to prevent a peculiar smell emitted from fermented food residue particles after being accumulated for a long time in a pipe part between a U-shaped structure of a sewer pipe and the discharge outlet 2 from fleeing into the food waste disposer, or to prevent a sewage in the sewer pipe from flowing back into the food waste disposer, or to prevent insects in the sewer pipe from crawling into the food waste disposer.

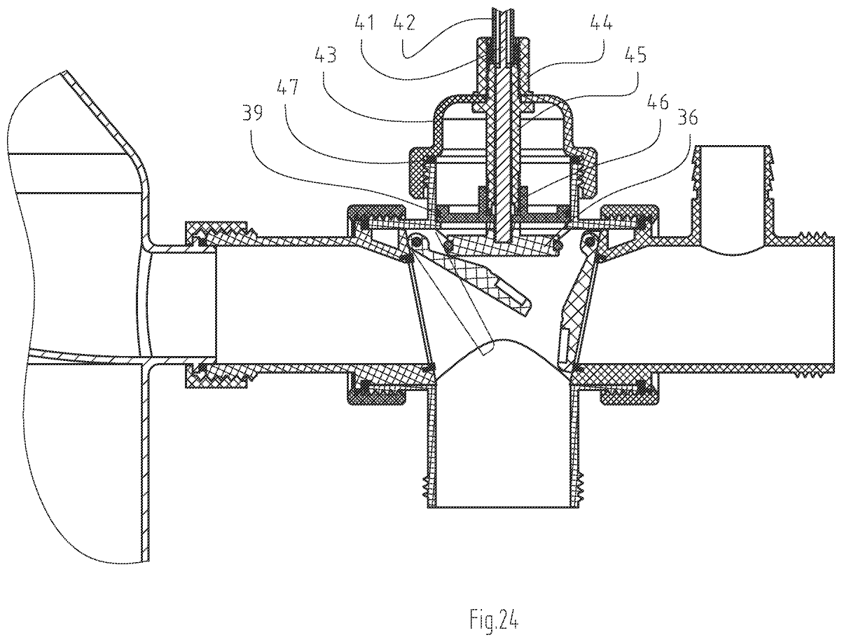

Referring to FIG. 24 and FIG. 29, the connecting component 4 comprises a retainer sleeve 42; a core part 41 accommodated in the retainer sleeve 42 and sliding relative to the retainer sleeve 42; an end cover 43 threadedly coupled with the second pipe 32; a first adapter sleeve 44 and a second adapter sleeve 45 coaxially penetrating through the end cover 43 to fasten the retainer sleeve 42; and a grommet 46 screwed to the second adapter sleeve 45 close to the discharge outlet 2 for sealing. The end cover 43 is fastened to the second pipe 32 by a threaded connection manner, the end cover 43 and the second pipe 32 are sealed by the fifth sealing ring 47. An end of the core part 41 of the connecting component 4 close to the discharge outlet 2 penetrates the second pipe 32 and is tightly coupled with the limit block 36 of the switching component 3 through a threaded connection manner. The core part 41 is slidable relative to the second pipe 32, the grommet 46 is hermetically connected with the second pipe 32 of the switching component 3 through a third sealing ring 39.

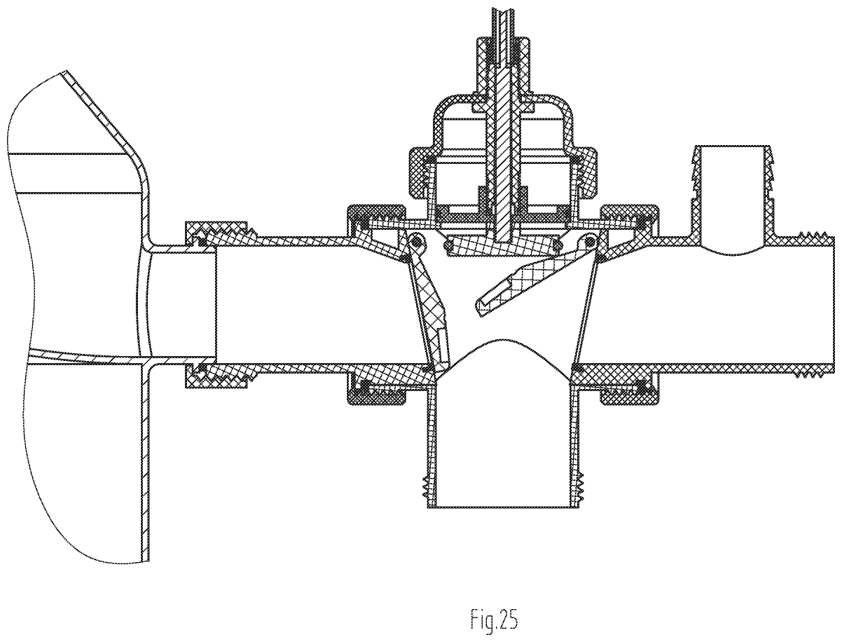

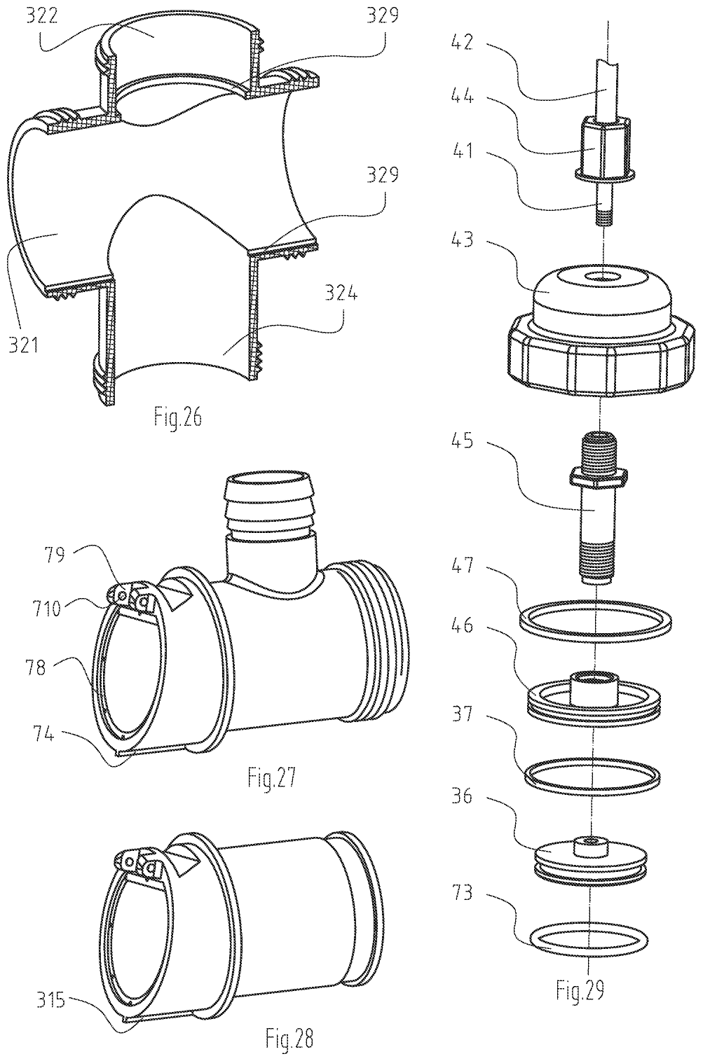

In order to enable an end of the core part 41 close to the discharge outlet 2 to slide relative to the second pipe 32, the second pipe 32 is provided with a central hole coaxially along the end of the core part 41, a rim 711 extending inward coaxially with the central hole is formed for receiving the grommet 46, as shown in FIG. 26. The second adapter sleeve 45 is fastened to the end cover 43 through a threaded connection of the first adapter sleeve 44 and the second adapter sleeve 45, a circumferential surface of the grommet 46 is radially inwardly provided with a third groove for partially receiving the third sealing ring 39, sealing and isolation between an inside of the second pipe 32 and an inside of the end cover 43 is achieved through a hermetic fit of the third sealing ring 39 and an inner wall 584 of the second pipe 32; therefore, sewage in the second pipe 32 is prevented from entering the inside of the end cover 43 through the central hole.

Referring to FIG. 26, the second pipe 32 is provided with multiple nozzles to allow pipe connection of other equipments in kitchen and connection with the sewer pipe. The second pipe 32 is provided with a first nozzle 321 for socketing an inclined end of the first pipe 31, an outer peripheral surface of the first nozzle 321 is provided with a thread and is detachably connected to the first pipe 31 through the second tube nut 310. An airtight connection of the first nozzle 321 between the first pipe 31 and the second pipe 32 is realized by a fourth sealing ring 37. The second pipe 32 is provided with a second nozzle 322 coaxially along an anti-gravity direction and is connected with the connecting component 4 in a threaded connection manner, the second pipe 32 is provided with a third nozzle 323 for socketing an inclined end of the third pipe 7, an outer peripheral surface of the third nozzle 323 is provided with threads and is detachably connected with the third pipe 7 through a third tube nut 71, a sealed connection between the third pipe 7 and the third nozzle 323 of the second pipe 32 is realized by a seventh sealing ring 72. The second pipe 32 is coaxial with the second nozzle 322 and is provided with a fourth nozzle 324 along a gravity direction and is connected with the sewer pipe in a threaded connection manner. The first nozzle 321 and the third nozzle 323 each extends a fourth groove 329 along an axial direction of each peripheral surface, the fourth groove 329 is used for cooperating with a rib of the first pipe 31 or the third pipe 7 to limit a rotation of the first pipe 31 or the third pipe 7, and is used for positioning when the first pipe 31 or the third pipe 7 is installed.

Referring to FIG. 27, the third pipe 7 is arranged coaxially away from the inclined surface with an nozzle for connecting with other kitchen equipment and arranged with a quick-plug nozzle for connecting with an overflow pipe of the sink arranged perpendicular to an axial direction. When the two nozzles are not activated, an automatic closing function of the second baffle 75 can prevent an intrusion of peculiar smell, sewage and insects from the sewer pipe without installing a stuffing cover. When the two nozzle are connected to drainage outlets of other equipments, under an action of water flow, the second baffle 75 flips in an anti-gravity direction and discharges water into the sewer pipe, as shown in FIG. 25. The second baffle 75 is automatically closed under gravity action after water is drained. The inclined end of the third pipe 7 is also provided with a second rib 74 extending in an axial direction. The second rib 74 is used to cooperate with the fourth groove 329 of the second pipe 32 to restrict a rotation of the third pipe 7 and is used for positioning when installing the third pipe 7.

Referring to FIG. 28, the inclined end of the first pipe 31 is provided with a first rib 315 extending in an axial direction. The first rib 315 is used to cooperate with the fourth groove 329 of the second pipe 32 to restrict a rotation of the first pipe 31 and is used for positioning when installing the first pipe 31.

Referring to FIG. 23, the first baffle 34 and the second baffle 75 are symmetrically arranged on both sides of the limit block 36, the limit block 36 can slide back and forth along an symmetry axis. A closed state of the first baffle 34 or the second baffle 75 is locked when the limit block 36 abuts the first baffle 34 or the second baffle 75. The limit block 36 releases a locking state of both when the limit block 36 is far away from the first baffle 34 or the second baffle 75, as shown in FIG. 24 and FIG. 25.

In order to improve a locking reliability of the limit block 36 to baffles, a fifth groove extending radially inward is provided on a circumferential surface of the limit block 36. The fifth groove partially receives an eighth sealing ring, and the eighth sealing ring protrudes from a peripheral surface of the limit block 36 so that the first baffle 34 and the second baffle 75 are in pressing contact with the eighth sealing ring. Under an action of an elastic force of the eighth sealing ring, it is ensured that the limit block 36 always has a force on the first baffle 34 or the second baffle 75 so that the first baffle 34 or the second baffle 75 always presses a corresponding sealing ring to ensure a closed state reliable. The eighth sealing ring is sleeved through the limit block 36 to improve a feel of the pressing operation of a movable end 52 of the control component 5 so that a pressing process has a certain cushioning feel. In order to keep the first baffle 34 or the second baffle 75 in a closed and locked state under an action of the limit block 36, a sixth groove 342 is provided on a plane that cooperates with the eighth sealing ring on the first baffle 34 or the second baffle 75, as shown in FIG. 33.

The sixth groove 342 is used to partially receive the eighth sealing ring, the eighth sealing ring is locked into the sixth groove 342 to keep the limit block 36 at a current position after the limit block 36 abuts the first baffle 34 or the second baffle 75. Therefore it is avoided that a displacement of the limit block 36 causes the first baffle 34 or the second baffle 75 to close unreliably, as shown in FIG. 23. In order to obtain a larger open state of the first baffle 34, an inclined surface inclined to the first pin 35 is provided close to the first baffle 34, the inclined surface abuts the limit block 36 to enable the first baffle 34 to obtain a larger open state. Referring to FIG. 24, dotted lines indicate a maximum open state of the first baffle 34 without the inclined surface. Similarly, the second baffle 75 can be opened to a larger state. In order to make the first baffle 34 or the second baffle 75 have a faster automatic closing speed, the first baffle 34 or the second baffle 75 is provided with a third blind hole 343, the third blind hole 343 is used to receive a clump weight with appropriate weight, as shown in FIG. 33.

### Embodiment Three

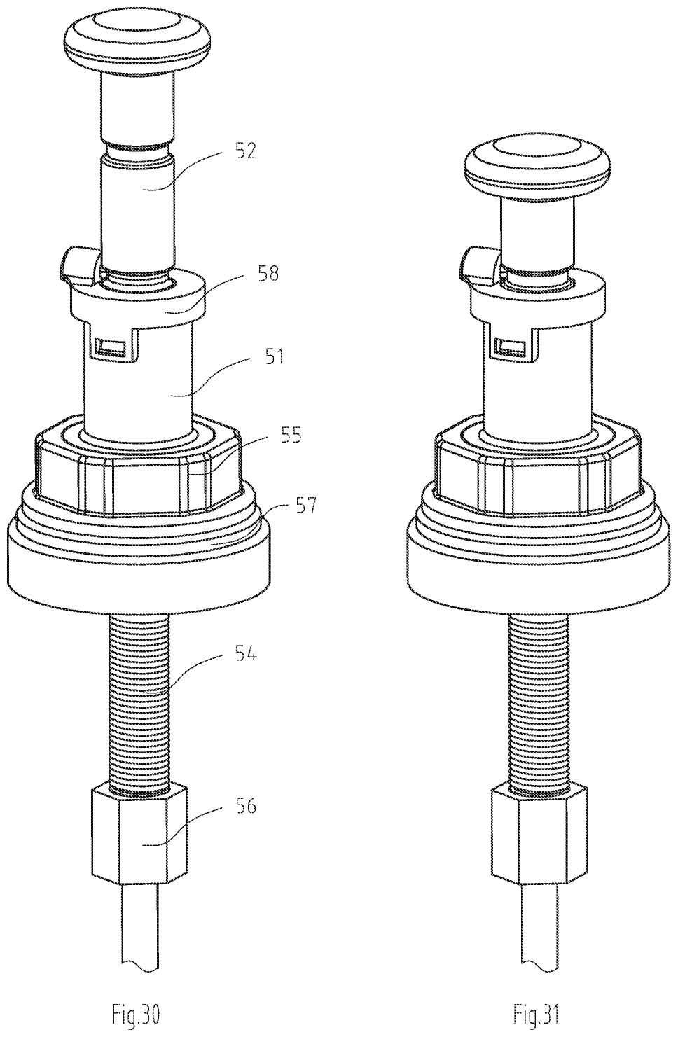

Another example of a control component 5 of the present invention is shown in FIG. 30. The control component 5 comprises a first fixing base 51; a movable end 52; a response unit 58; a clamp nut 55; a washer 57; a second fixing base 54; and a third adapter sleeve 56. The movable end 52 is inserted into the first fixing base 51 and can slide axially relative to the first fixing base 51, the response unit 58 is coaxially fastened to the first fixing base 51 by a buckle, the response unit 58 is used to respond to a moving position of the movable end 52 relative to the first fixing base 51. The movable end 52 has a first position and a second position, the movable end 52 can be moved from the first position to the second position by pressing the movable end 52, as shown in FIG. 31. The movable end 52 can be moved from the second position to the first position by pulling the movable end 52, as shown in FIG. 30. The clamp nut 55 is coaxially arranged on a side of the first fixing base 51 close to the movable end 52 in a threaded connection manner, the control component 5 is installed at a proper position by the clamp nut 55, in order to improve a fastening effect, the washer 57 is arranged between the first fixing base 51 and the clamp nut 55, material of the washer 57 is preferably rubber. The second fixing base 54 is detachably fastened to a side of the first fixing base 51 away from the movable end 52 in a threaded connection manner, the third adapter sleeve 56 is coaxially arranged on a side of the second fixing base 54 away from the movable end 52 in a threaded connection manner, the third adapter sleeve 56 is used to fasten a retainer sleeve 42 of a connecting component 4 to the control component 5.

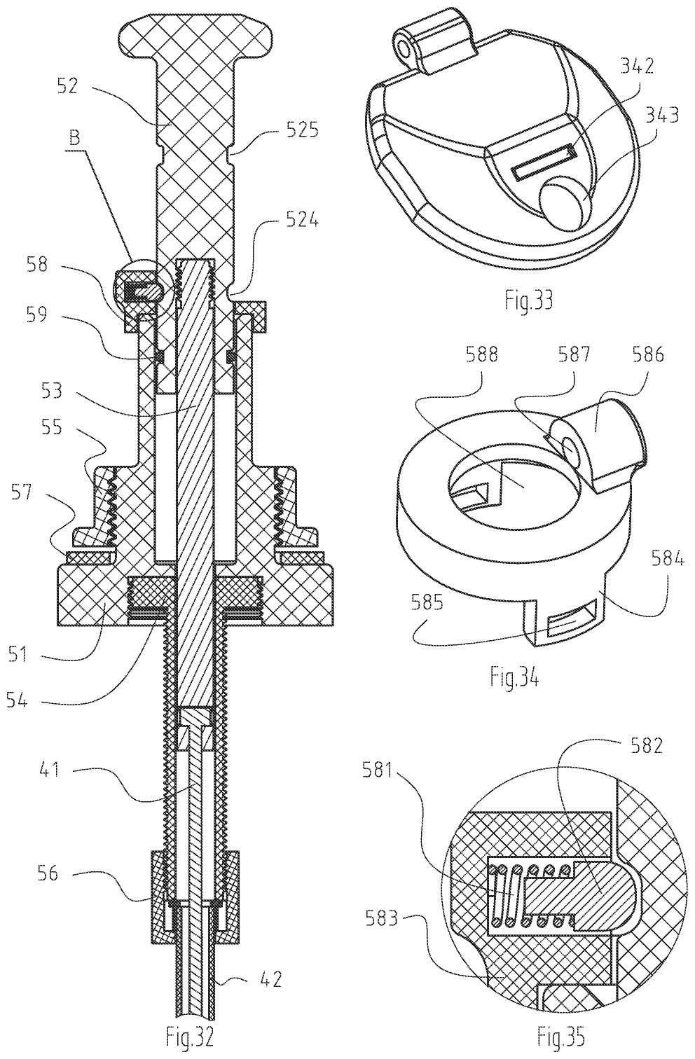

Referring to FIG. 32, the control component 5 further comprises a connecting rod; and a ninth sealing ring. The connecting rod is coaxially fastened to the movable end 52 in a threaded connection manner and extends in a direction away from the movable end 52 to be hung with a core part 41 of the connecting component 4, the retainer sleeve 42 of the connecting component 4 is fastened to the control component 5 through the third adapter sleeve 56. Therefore the movable end 52 can drive the core part 41 of the connecting component 4 to move relative to the retainer sleeve 42 by pressing or pulling the movable end 52 so as to move the limit block 36 in a switching component 3. The limit block 36 is far away from the first baffle 34 or the second baffle 75 when the movable end 52 is located at the first position. The limit block 36 abuts the first baffle 34 or the second baffle 75 when the movable end 52 is located at the second position. In order to prevent external water from entering an inside of the control component 5 during an axial sliding of the movable end 52 relative to the first fixing base 51, a ninth sealing ring is arranged between the movable end 52 and the first fixing base 51. The ninth sealing ring is partially embedded in the movable end 52, the ninth sealing ring closely fits with an inner wall 584 of the first fixing base 51.

Referring to FIG. 36, the movable end 52 comprises a shaft portion 528 and a handle end 527, the shaft portion 528 is in clearance fit with the first fixing base 51 so as to realize an axial sliding of the shaft portion 528 relative to the first fixing base 51 and rotation around an axis of the shaft portion 528, the handle end 527 is coaxially arranged at an end of the shaft portion 528 away from the first fixing base 51 for users to hold. The shaft portion 528 is axially provided with a third slot 526, a first slot 524, and a second slot 525 spaced a certain distance in sequence, the second slot 525 is close to the handle end 527, the third slot 526 is away from the handle end 527. The first slot 524, the second slot 525, and the third slot 526 extend radially inwardly, the ninth sealing ring is sleeved in the third slot 526.

The response unit 58 comprises a third fixing base 583; a push rod 582; and a spring. The third fixing base 583 is sleeved on the first fixing base 51 close to the movable end 52, the spring causes the push rod 582 to move relative to the third fixing base 583 and intermittently snap into the first slot 524 or the second slot 525 of the movable end 52.

Referring to FIG. 34, the third fixing base 583 has a disc structure, a side of the disc matched with the first fixing base 51 axially extends two symmetrical wall 584s, the wall 584s are provided with a fifth through hole 585 penetrating the wall 584s along a radial direction of the disc, the disc is provided with a sixth lug 586 protruding from the disc close to the handle end 527, the sixth lug 586 is provided with a fourth blind hole 587, the fourth blind hole 587 extends outward along a radial direction of the disc, the disk is coaxially provided with a sixth through hole 588 penetrating the disk. A bore diameter of the sixth through hole 588 is slightly larger than a diameter of the shaft portion 528 of the movable end 52 so that the movable end 52 can move and rotate relative to the third fixing base 583. The fifth through hole 585 of the wall 584 is used to receive a seventh lug 515 of the first fixing base 51 so that the third fixing base 583 is fastened to the first fixing base 51 through a cooperation of the fifth through hole 585 and the seventh lug 515. The seventh lug 515 protrudes radially outward along a circumferential surface of the first fixing seat, the seventh lug 515 is provided with an inclined surface close to the movable end 52 so that the wall 584 of the third fixing base 583 is radially expanded when abutting the seventh lug 515 so that the seventh lug 515 can insert into the fifth through hole 585 of the wall 584.

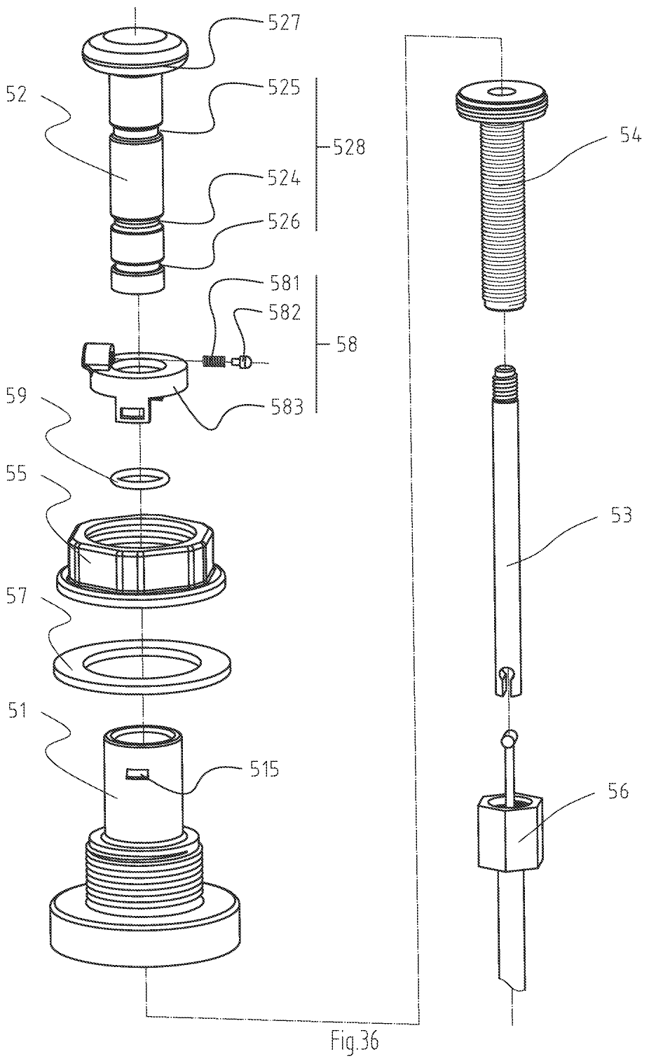

Referring to FIG. 35, the spring is received in the fourth blind hole 587 of the third fixing base 583, the push rod 582 is partially received in the fourth blind hole 587, the push rod 582 can move axially relative to the fourth blind hole 587, the push rod 582 partially protrudes from the fourth blind hole 587, the push rod 582 is clamped into the first slot 524 or the second slot 525 of the shaft portion 528 of the movable end 52 under an action of the spring. In order to make an end of the push rod 582 smoothly fit into the first slot 524 or the second slot 525, the end of the push rod 582 is set in a spherical shape. A connection part between the first slot 524 or the second slot 525 and the shaft portion 528 is transitioned by a circular arc surface, so when the movable end 52 is pressed or pulled, the push rod 582 can smoothly enter and exit the first slot 524 or the second slot 525. At a moment when the end of the push rod 582 slides into the first slot 524 from the shaft portion 528, the push rod 582 hits the first slot 524 or the second slot 525 under an action of elastic force to make a sound, thereby prompting users that the movable end 52 is currently at the first position or the second position. After the push rod 582 is inserted into the first slot 524, the movable end 52 can be kept at a current position so that the limit block 36 in the switching component 3 is kept away from the first baffle 34 or the second baffle 75; therefore, it is avoided that the limit block 36 moves downward due to gravity action and causing the limit block 36 to abut the first baffle 34 or the second baffle 75 when it is not required for work. After the push rod 582 is locked into the second slot 525, the movable end 52 can be kept at a current position so that the limit block 36 in the switching component 3 is kept at a position of abutting the first baffle 34 or the second baffle 75; therefore, it is avoided that the limit block 36 moves due to a pressure of water in a pipe pushing the first baffle 34 or the second baffle 75, and the limit block 36 loses a limit function.

### Embodiment Four

An example of an integrated sink of the present invention is shown in FIG. 37. The integrated sink comprises a sink; a faucet installed above the sink; and a food waste disposer connected below the sink. The food waste disposer is according to Embodiment one or Embodiment two, a feed inlet 1 of the food waste disposer is connected with a drain outlet of the sink, a control component 5 is arranged on a countertop of the sink, a connecting component 4 is a flexible element to allow the control component 5 to be flexibly installed on a countertop of the sink so as to facilitate a user operation. A switching component 3 is also provided with multiple nozzles to allow pipe connection of other equipments in a kitchen and connection with a sewer pipe.

Arrange the switching component 3 to a discharge outlet 2 and make the switching component 3 close the discharge outlet 2 through the control component 5, water in the sink flows into a cavity 6 through the feed inlet 1 of the food waste disposer and fills the cavity 6 of the food waste disposer. The switching component 3 is closed by operating the control component 5 arranged on the countertop of the sink. Water in the cavity 6 is driven by a pulverizing component to flush the cavity 6, components in the cavity 6, and all corners of the cavity 6 so as to realize a clean cleaning of the cavity 6 and avoid a generation of peculiar smell. Therefore the integrated sink disclosed in this embodiment can clean the cavity 6 of the food waste disposer without disassembling the food waste disposer.

### Embodiment Five

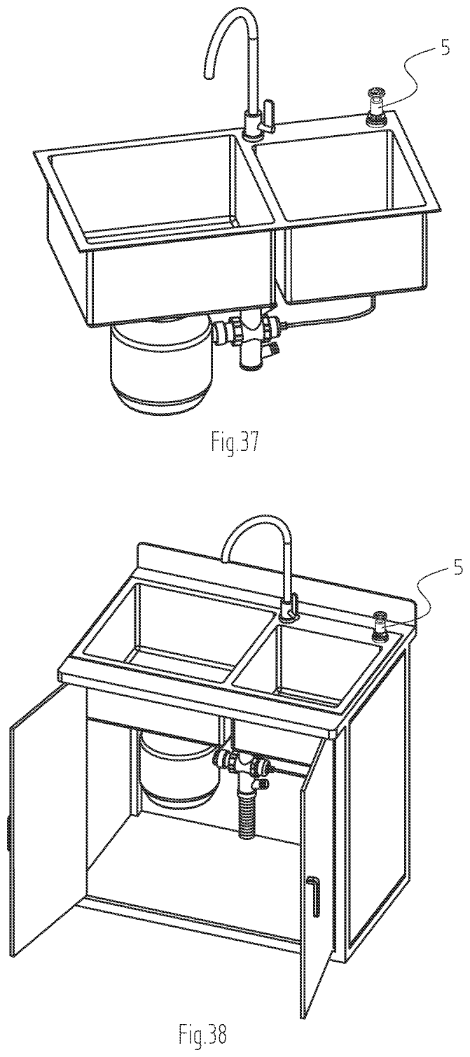

An example of an integrated cabinet of the present invention is shown in FIG. 38, in order to facilitate a display of an internal structure of the integrated cabinet, FIG. 38 shows the integrated cabinet with doors open. The integrated cabinet comprises a cabinet; a sink embedded in a countertop of the cabinet; a faucet installed above the sink; and a food waste disposer connected below the sink. The food waste disposer is according to Embodiment one or Embodiment two, a feed inlet 1 of the food waste disposer is connected with a drain outlet of the sink, a control component 5 is arranged on a countertop of the sink, a connecting component 4 is a flexible element to allow the control component 5 to be flexibly installed on a countertop of the sink so as to facilitate a user operation. A switching component 3 is also provided with multiple nozzles to allow pipe connection of other equipments in a kitchen and connection with a sewer pipe.

Arrange the switching component 3 to a discharge outlet 2 and make the switching component 3 close the discharge outlet 2 through the control component 5, water in the sink flows into a cavity 6 through the feed inlet 1 of the food waste disposer and fills the cavity 6 of the food waste disposer. The switching component 3 is closed by operating the control component 5 arranged on the countertop of the sink. Water in the cavity 6 is driven by a pulverizing component to flush the cavity 6, components in the cavity 6, and all corners of the cavity 6 so as to realize a clean cleaning of the cavity 6 and avoid a generation of peculiar smell. Therefore the integrated cabinet disclosed in this embodiment can clean the cavity 6 of the food waste disposer without disassembling the food waste disposer.

1. A food waste disposer, comprising:
a feed inlet (1);
a discharge outlet (2);
a cavity (6) arranged between the feed inlet (1) and the discharge outlet (2);
a pulverizing component arranged in the cavity (6) for pulverizing materials;
a driving component arranged outside the cavity (6) for driving the pulverizing component; and
a power input terminal for driving the driving component to work;
wherein the food waste disposer further comprises:
a switching component (3) connected to the discharge outlet (2);
a control component (5) driving the switching component (3) to close; and
a connecting component (4) connecting the switching component (3) and the control component (5);
the switching component (3) comprising:
a first pipe (31) arranged along a discharge direction of the discharge outlet (2);
a first baffle (34) that is arranged at an end of the first pipe (31) away from the discharge outlet (2) and used to prevent discharge and can be turned against gravity direction;
a first sealing ring (33) arranged between the first pipe (31) and the first baffle (34); and
a retractable limit block (36) controlled by the control component (5) to prevent the first baffle (34) from turning over through the connecting component (4);
wherein the first pipe (31) comprises a channel arranged therein, the channel connecting the discharge outlet (2) with a sewer pipe.

2. The food waste disposer according to claim 1, wherein an end of the first pipe (31) of the switching component (3) away from the discharge outlet (2) is provided with an inclined surface inclined to the discharge outlet (2), a first groove (312) for partially receiving the first sealing ring (33) being arranged perpendicular to the inclined surface, a first blind hole (313) that is in interference fit with the first sealing ring (33) being arranged perpendicular to the first groove (312), a pair of first lug (311)s being arranged perpendicular to the inclined surface along a direction away from the discharge outlet (2), the first lug (311) being provided with a first through hole (314) for clearance matching with a first pin (35);
the first sealing ring (33) comprising an outer shape corresponding to the first groove (312) provided on the inclined surface of the first pipe (31); and a pillar (331) that is interference fit with the first blind hole (313);
the first sealing ring (33) being arranged between the inclined surface of the first pipe (31) and the first baffle (34) and protruding from the inclined surface, the first baffle (34) comprising an outer shape corresponding to the inclined surface of the first pipe (31); and a second lug (341) that is rotatably coupled with the first lug (311) provided on the inclined surface through the first pin (35); the limit block (36) sliding along an axial direction of the first pipe (31) or a direction of gravity under control of the control component (5) after the limit block (36) is connected to the connecting component (4); an end of the limit block (36) close to the discharge outlet (2) being used to limit the first baffle (34) turning so that the first baffle (34) abuts the first sealing ring (33) to prevent material from being discharged.

3. The food waste disposer according to claim 2, wherein the switching component (3) further comprises:
a second pipe (32) partially sleeved with the first pipe (31) away from the discharge outlet (2);
a third pipe (7) arranged coaxially with the first pipe (31);
a second baffle (75) arranged to the third pipe (7) to prevent discharging; and
a second sealing ring (76) arranged between the third pipe (7) and the second baffle (75);
wherein the second baffle (75) is reversed in gravity direction, the third pipe (7) and the first pipe (31) being arranged symmetrically with respect to a central plane of the second pipe (32) perpendicular to a discharge direction, the second pipe (32) being partially sleeved with the third pipe (7) close to the end of the discharge outlet (2), an end of the limit block (36) away from the discharge outlet (2) being used to limit the second baffle (75) turning so that the second baffle (75) abuts the second sealing ring (76) to prevent material from being discharged.

4. The food waste disposer according to claim 3, wherein the connecting component (4) comprises:
a retainer sleeve (42);
a core part (41) accommodated in the retainer sleeve (42) and sliding relative to the retainer sleeve (42);
an end cover (43) threadedly coupled with the second pipe (32);
a first adapter sleeve (44) and a second adapter sleeve (45) coaxially penetrating through the end cover (43) to fasten the retainer sleeve (42); and
a grommet (46) screwed to the second adapter sleeve (45) close to the discharge outlet (2) for sealing;
wherein an end of the core part (41) of the connecting component (4) close to the discharge outlet (2) penetrates the second pipe (32) and being coupled with the limit block (36) of the switching component (3) through a threaded connection manner, the grommet (46) being hermetically connected with the second pipe (32) of the switching component (3) through the third sealing ring (39);
the control component (5) comprising:
a first fixing base (51);
a movable end (52) coaxially inserted into the first fixing base (51);
a response unit (58) coaxially fastened to the first fixing base (51) for responding to a moving position of the movable end (52);
a connecting rod that is coaxially fastened and connected to the movable end (52) and extends in a direction away from the movable end (52);
a second fixing base (54) that is coaxially and detachably fastened to the first fixing base (51) away from the movable end (52) by a threaded connection manner;
a clamp nut (55) coaxially arranged on the first fixing base (51) in a threaded connection manner for installing the control component (5) at a proper position; and
a third adapter sleeve (56) that is coaxially arranged on the second fixing base (54) away from the movable end (52) in a threaded connection manner for fastening the retainer sleeve (42) of the connecting component (4) to the control component (5);
wherein the movable end (52) comprises a shaft portion (528) that is slidingly fitted with the first fixing base (51), the shaft portion (528) being axially provided with a first slot (524) and a second slot (525) spaced a certain distance apart, the first slot (524) and the second slot (525) extending radially inwardly;
the response unit (58) comprising:
a third fixing base (583) sleeved on the first fixing base (51) close to the movable end (52);
an push rod (582) intermittently inserting into the first slot (524) or the second slot (525) of the movable end (52); and
an elastic component (581) for moving the push rod (582) relative to the third fixing base (583) and snapping into the first slot (524) or the second slot (525) along a radial direction of the movable end (52).

5. The food waste disposer according to claim 3, wherein the connecting component (4) comprises:
a retainer sleeve (42);
a core part (41) accommodated in the retainer sleeve (42) and sliding relative to the retainer sleeve (42);
an end cover (43) threadedly coupled with the second pipe (32);
a first adapter sleeve (44) and a second adapter sleeve (45) coaxially penetrating through the end cover (43) to fasten the retainer sleeve (42); and
a grommet (46) screwed to the second adapter sleeve (45) close to the discharge outlet (2) for sealing;
wherein an end of the core part (41) of the connecting component (4) close to the discharge outlet (2) penetrates the second pipe (32) and is coupled with the limit block (36) of the switching component (3) through a threaded connection, the grommet (46) being hermetically connected with the second pipe (32) of the switching component (3) through the third sealing ring (39);
the control component (5) comprising:
a first fixing base (51);
a movable end (52) coaxially inserted into the first fixing base (51);
a connecting rod that is coaxially fastened and connected to the movable end (52) and extends in a direction away from the movable end (52);
a second fixing base (54) that is coaxially and detachably fastened to the first fixing base (51) away from the movable end (52) by a threaded connection;
a clamp nut (55) coaxially arranged on the second fixing base (54) in a threaded connection manner for installing the control component (5) in a proper position; and
a third adapter sleeve (56) that is coaxially arranged on the second fixing base (54) away from the movable end (52) in a threaded connection manner for fastening the retainer sleeve (42) of the connecting component (4) to the control component (5);
a cylindrical surface of the first fixing base (51) being axially provided with a first slideway (513), an end of the first slideway (513) away from the movable end (52) extending along the cylindrical surface to form a second slideway (514), the second slideway (514) being perpendicular to the first slideway (513), the first slideway (513) being connected to the second slide;
the movable end (52) having a shaft portion (528) slidingly fitted with the first fixing base (51), the shaft portion (528) extending radially outward to form a fifth lug (523), the fifth lug (523) sliding in the first slideway (513) or the second slideway (514), the movable end (52) being slidably connected to the first slideway (513) through the fifth lug (523) to move the movable end (52) along an axial direction of the first fixing base (51), the movable end (52) rotating around an axis of the first fixing base (51) through a sliding connection between the fifth lug (523) and the second slideway (514) when the fifth lug (523) slides into the second slideway (514), the second slideway (514) restricting an axial movement of the movable end (52).

6. The food waste disposer according to claim 5, wherein the cylindrical surface of the first fixing base (51) is inlaid with a first magnet (511) near the second slideway (514), the fifth lug (523) of the movable end (52) being inlaid with a second magnet (521), poles of the first magnet (511) and the second magnet (521) being opposite to each other so that the fifth lug (523) enters the second slideway (514) due to action of magnetic force to drive the movable end (52) rotate when the fifth lug (523) is located at a junction between the first slideway (513) and the second slideway (514);
the first slideway (513) and the second slideway (514) constituting an L-shaped slideway, the first fixing base (51) being provided with two L-shaped slideways that are distributed on the cylindrical surface of the first fixing base (51) in a circular array with an axis of the first fixing base (51) as a central axis and spaced by 180 degrees;
the first fixing base (51) being provided with a third magnet (512), the first magnet (511) and the third magnet (512) being embedded in the first fixing base (51) in a circular array with an axis of the first fixing base (51) as a central axis and spaced by 180 degrees;
the movable end (52) being providing with two fifth lug (523)s that are distributed in a circular array with an axis of the movable end (52) as a central axis and spaced by 180 degrees;
the fifth lug (523) being providing a fourth lug (571), the second magnet (521) and the fourth magnet (522) being embedded in the fifth lug (523) in a circular array with an axis of the movable end (52) as a central axis and spaced by 180 degrees;
poles of the third magnet (512) and the fourth magnet (522) being opposite to each other.

7. An integrated sink, comprising:
a sink;
a faucet installed above the sink; and
a food waste disposer connected below the sink;
wherein the food waste disposer is according to claim 1, the feed inlet (1) of the food waste disposer being connected with a drain outlet of the sink, the control component (5) being arranged on a countertop of the sink.

8. An integrated sink, comprising:
a cabinet;
a sink embedded in a countertop of the cabinet;
a faucet installed above the sink; and
a food waste disposer connected below the sink;
wherein the food waste disposer is according to claim 1, the feed inlet (1) of the food waste disposer being connected with a drain outlet of the sink, the control component (5) being arranged on a countertop of the sink.
